(19) United States
(12) Patent Application Publication
(10) Pub. No.: US 2008/0055667 A1
(43) Pub. Date: Mar. 6, 2008

(54) IMAGE PROCESSING APPARATUS, IMAGE PROCESSING METHOD, AND RECORDING MEDIUM

(76) Inventor: Hiroshi BABA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/849,777

(22) Filed: Sep. 4, 2007

(30) Foreign Application Priority Data
Sep. 5, 2006 (JP) 2006-240748
Sep. 5, 2006 (JP) 2006-240749

(51) Int. Cl. H04N 1/40

(52) U.S. Cl. 358/448

(57) ABSTRACT

An image processing apparatus to which a plug-in can be added is disclosed. The plug-in has at least one filter corresponding to a process constituting a job for conducting an image processing operation. The image processing apparatus includes a plug-in managing part for managing the plug-in and a plug-in registration requesting part for requesting the plug-in management part to register the plug-in in a case where the image processing apparatus is activated or where the plug-in is added to the image processing apparatus.

### BACKGROUND OF THE INVENTION

1. Field of the Invention

The present invention relates to an image processing apparatus, an image processing method, and a recording medium.

2. Description of the Related Art

Conventionally, an image processing apparatus having plural functions (e.g., image forming apparatus) is provided with a device corresponding to each function. The image processing apparatus also is provided with a control part (e.g., software) for controlling the devices and an image processing part for performing various processes on images. However, as functions of image processing apparatuses become diverse and as types/grades of image processing apparatuses increase, the number of combinations of devices included in image processing apparatuses are increasing. As a result, since the conventional image processing apparatuses require development of the control part and the image processing part for each combination, both time and cost are increasing for such development. Accordingly, various methods are proposed for conducting efficient development of image processing apparatuses and improving productivity of image processing apparatuses.

For example, in an image processing apparatus disclosed in Japanese Registered Patent No. 3679349 (hereinafter referred to as “Patent Document 1”, a part for realizing various functions of the image processing apparatus is further divided into a part(s) corresponding to a unique function and a part(s) shared by plural functions. By doing so, efficient development of image processing apparatuses can be conducted and productivity of image processing apparatuses can be improved. More specifically, the image processing apparatus is provided with an application(s) (printer application, copier application, scanner application) corresponding to each function included in an image processing apparatus. Furthermore, the image processing apparatus is provided with a service module(s) corresponding to each service commonly used by plural applications. With the configuration disclosed in Patent Document 1, a corresponding application is added or updated whenever a device that realizes a function of an image forming apparatus is added or updated. Accordingly, the device can be added or changed without affecting other applications.

However, with the technology of the image forming apparatus and the like disclosed in Patent Document 1, whenever a function of an image forming apparatus or a device that realizes the function of the image forming apparatus is added or updated, there is a need to change add/update an application or a control part for realizing the added/updated function as well as to change a service module associated to the application or control part and/or the user-interface associated to the application or control part (e.g., in a case of changing an operations panel of the image processing apparatus disclosed in Patent Document 1, all user-interfaces associated to the applications of the image processing apparatus are to be changed). Therefore, the technology disclosed in Patent Document 1 generates a heavy workload in the development process and is therefore unable to achieve efficient development.

Furthermore, with the technology disclosed in Patent Document 1, the types of functions of the image forming apparatuses are constrained to the functions existing at the time of manufacturing the image forming apparatus. Therefore, in a case of adding functions that were not anticipated at the time of manufacturing the image forming apparatus, many changes are required including changes of the service module.

Furthermore, with the technology disclosed in Patent Document 1, in a case of changing an application or a service module, the image forming apparatus requires re-booting and it is difficult to change the configuration of the image forming apparatus.

### SUMMARY OF THE INVENTION

The present invention may provide an image processing apparatus, an image processing method, and a recording medium that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an image processing apparatus, an image processing method, and a recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing apparatus to which a plug-in can be added, the plug-in having at least one filter corresponding to a process constituting a job for conducting an image processing operation, the image processing apparatus including: a plug-in managing part for managing the plug-in; and a plug-in registration requesting part for requesting the plug-in management part to register the plug-in in a case where the image processing apparatus is activated or where the plug-in is added to the image processing apparatus.

Furthermore, another embodiment of the present invention provides an image processing method used for an image processing apparatus to which a plug-in including at least one filter corresponding to a process constituting a job for conducting an image processing operation, the image processing apparatus including a plug-in managing part for managing the plug-in and a filter managing part for managing the filter, the image processing method including: a plug-in registration requesting step for requesting the plug-in management part to register the plug-in in a case where the image processing apparatus is activated or where the plug-in is added to the image processing apparatus.

Furthermore, another embodiment of the present invention provides a computer-readable recording medium on which a program is recorded for causing a computer to execute an image processing method used for an image processing apparatus to which a plug-in including at least one filter corresponding to a process constituting a job for conducting an image processing operation, the image processing apparatus including a plug-in managing part for managing the plug-in and a filter managing part for managing the filter, the image processing method including: a step for requesting the plug-in management part to register the plug-in in a case where the image processing apparatus is activated or where the plug-in is added to the image processing apparatus.

Other objects and further features of the present invention will be apparent from the following detailed description when read in conjunction with the accompanying drawings.

### BRIEF DESCRIPTION OF THE DRAWINGS

FIG. 1 is a schematic view showing an exemplary configuration including parts (components) for executing a job(s) of an image processing apparatus according to an embodiment of the present invention;

FIG. 2 is a schematic diagram for describing a concept of a pipe & filter architecture according to an embodiment of the present invention;

FIG. 3 is a schematic diagram showing an exemplary function configuration related to registration of plug-ins of a MFP 1 and registration of a filter included in a plug-in of a MFP 1 according to an embodiment of the present invention;

FIG. 4 is a schematic diagram for describing a logical relationship between a filter and a filter UI according to an embodiment of the present invention (Part 1);

FIG. 5 is a schematic diagram for describing a logical relationship between a filter and a filter UI according to an embodiment of the present invention (Part 2);

FIGS. 6A and 6B are schematic diagrams for describing a physical configuration of a filter and a filter user-interface (UI) according to an embodiment of the present invention;

FIG. 7 is a sequence diagram showing an exemplary operation of registering a filter of a plug-in in a plug-in managing part 210 according to an embodiment of the present invention;

FIG. 8 is a list including plug-in names and plug-in addresses stored in a plug-in address storing part 211 according to an embodiment of the present invention (Part 1);

FIGS. 9A-9D show information (data) that is output upon requesting registration in a plug-in managing part according to an embodiment of the present invention (Part 1);

FIGS. 10A and 10B show examples of a plug-in management table according to an embodiment of the present invention;

FIG. 11 is a sequence diagram showing an example of registering a filter(s) in the filter managing part 330 according to an embodiment of the present invention;

FIG. 12 shows an example of a filter management table according to an embodiment of the present invention;

FIG. 13 is a sequence diagram showing an operation of registering actions of a local UI part 11 and a request managing part 220 in a plug-in managing part 210 according to an embodiment of the present invention;

FIG. 14 is a sequence diagram showing an example of activation of a local UI part 11 and a request managing part 220 and obtainment of a filter management table by a local UI part 11 according to an embodiment of the present invention;

FIG. 15 shows an example of a control panel displayed on an operations panel of an MFP 1 according to an embodiment of the present invention;

FIG. 16 is a sequence diagram showing processes of setting a filter for realizing a job according to an embodiment of the present invention;

FIG. 17 shows an example of a screen of a filter UI according to an embodiment of the present invention;

FIG. 18 is a sequence diagram showing processes of a MFP 1 realizing a function of a filter 350a according to an embodiment of the present invention;

FIGS. 19A-19C show examples of a screen displayed on an operations panel when adding a filter including a filter UI to a MFP 1 according to an embodiment of the present invention;

FIG. 20 is a sequence diagram showing an example of a process of adding a filter including a filter UI to a MFP 1 according to an embodiment of the present invention (Part 1);

FIGS. 21A-21C are schematic diagrams for describing contents in a plug-in address storing part 211 before and after a plug-in including a filter 350a is added to a MFP 1 according to an embodiment of the present invention;

FIG. 22 is a sequence diagram showing an example of deleting a filter 350a from a MFP 1 according to an embodiment of the present invention;

FIG. 23 is a sequence diagram showing a case of activating an MFP 1 having a filter (printing filter) 350d operable to realize a printing function according to an embodiment of the present invention;

FIG. 24 is a sequence diagram showing processes of registering filters and filter UI of plug-ins in a plug-in managing part 210 according to an embodiment of the present invention;

FIG. 25 is a list including plug-in names and plug-in addresses stored in a plug-in address storing part 211 according to an embodiment of the present invention (Part 2);

FIGS. 26A and 26B show information (data) that is output upon requesting registration in a plug-in managing part according to an embodiment of the present invention (Part 2);

FIG. 27 is a sequence diagram showing processes of registering a filter in a filter managing part 330 according to an embodiment of the present invention;

FIG. 28 is a sequence diagram showing an example of a process of adding a filter including a filter UI to a MFP 1 according to an embodiment of the present invention (Part 2);

FIGS. 29A-29C are schematic diagrams for describing the contents in a plug-in address storing part 211 before and after a filter 360a is added to a MFP 1 according to an embodiment of the present invention; and

FIG. 30 is a sequence diagram showing an example of deleting a filter 360a from a MFP 1 according to an embodiment of the present invention.

### DESCRIPTION OF THE PREFERRED EMBODIMENTS

In the following, embodiments of the present invention are described with reference to the accompanying drawings.

### First Embodiment

### (Exemplary Configuration Parts for Executing a Job(s) of MFP1)

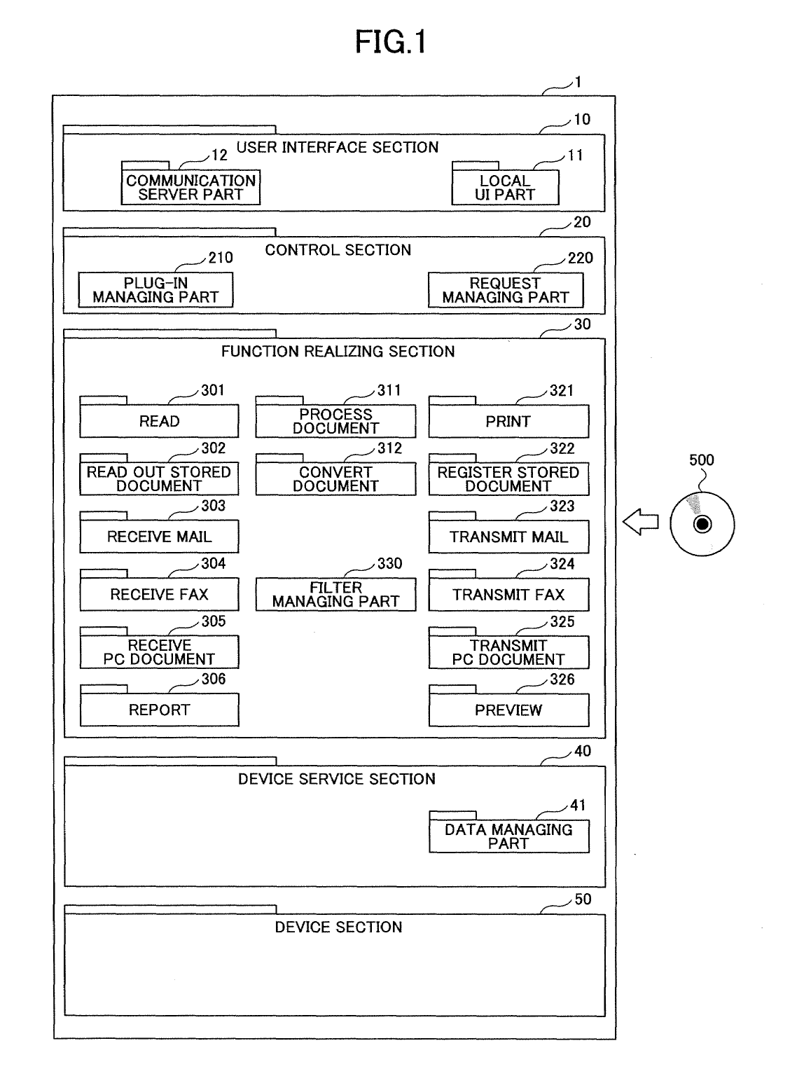

FIG. 1 is a schematic view showing an exemplary configuration including parts (components) for executing a job(s) of an image processing apparatus 1 according to an embodiment of the present invention. More specifically, FIG. 1 shows an exemplary configuration of software (program) for executing a job(s) of a multifunction peripheral (hereinafter also referred to as “MFP”) 1 serving as an image processing apparatus according to an embodiment of the present invention. In this example, a multifunction peripheral (MFP) is an image forming apparatus that realizes plural functions (e.g., printer function, copier function, scanner function, and facsimile function) with a single package (body).

In FIG. 1, the software of the MFP 1 includes a user interface section 10, a control section 20, a function realizing section 30, a device service section 40, and a device section (device control section) 50. The software of the MFP 1 according to an embodiment of the present invention can be recorded on various storage apparatuses, devices and media such as a computer-readable recording medium 500 for causing a computer to execute an image processing method used for the MFP 1. It is to be noted that the hierarchical relationship among the sections shown in FIG. 1 is based on a calling relationship among the sections. That is, FIG. 1 illustrates a relationship where the upper layers illustrated in FIG. 1 basically call the lower layers.

The user-interface section 10 includes parts (functions) for receiving requests for executing a job(s) (e.g., copying, printing, scanning, facsimile transmission). The user-interface section 10 includes, for example, a local user interface part (hereinafter also referred to as “local UI part”) 11 and a communication server part 12. For example, the local UI part 11 may receive requests input from an operations panel (not shown). For example, the communication server part 12 may receive requests from a client PC (not shown) via a network. The requests received at the user interface section 10 are transmitted to the control section 20.

The control section 20 includes parts (functions) for controlling one or more processes used for executing the requested job. The control section 20 includes, for example, a plug-in managing part 21 and a request managing part 220. The plug-in managing part 210 is for managing the physical addresses of parts in the MFP 1 used for executing the requested job and managing the operations corresponding to the parts.

In the embodiments of the present invention, the “plug-in”, being managed by the plug-in managing part 210, includes a program or a device corresponding to a function that is newly added to the basic functions of the MFP 1 and a program or a device corresponding to the basic functions of the MFP 1. That is, the plug-in managing part 210 is for managing the physical addresses of programs and devices corresponding to the basic functions and additional functions of the MFP 1 and managing the operations corresponding to the programs and devices corresponding to the basic functions and additional functions of the MFP 1.

The request managing part 220 is for connecting each filter in the function realizing section 30 according to the requested job and controlling the execution of the job based on the connected filter. In the embodiments of the present invention, the “job” of the MFP 1 corresponds to a single unit of services (starting from input of a request to its final output) provided to the user by the MFP 1. From the standpoint of software, the “job” of the MFP 1 corresponds to an application for providing a single unit of services.

The function realizing section 30 includes a group of components (parts) where each component (part) is for executing a portion(s) of the job provided by the MFP 1. That is, a single job is expressed by combining the components (parts) included in the function realizing section 30. In the embodiments of the present invention, each component is also referred to as a “filter”. This is based on a software architecture referred to as “pipes & filters” in a case where parts (components) for executing the job of the MFP 1 are installed as software, for example, in a computer-readable recording medium.

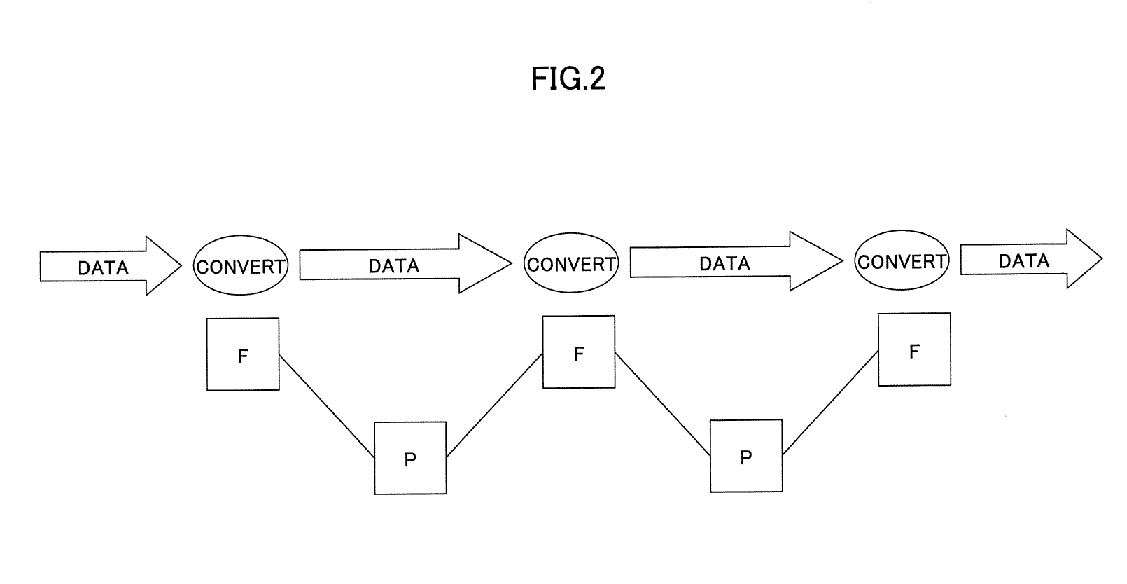

FIG. 2 is a schematic diagram for describing the concept of the pipes & filters architecture. In FIG. 2, the letter “F” indicates a filter and the letter “P” indicates a pipe. As shown in FIG. 2, each filter is connected to a pipe. The filter is for performing “conversion” on input data and outputting the result of the conversion. The pipe is for transmitting data output from a filter to the next filter.

Each function of the MFP 1 according to an embodiment of the present invention is regarded as a series of the above-described “conversions” performed on input data (e.g., document data). A job of the MFP 1 can be generalized to the procedures of “inputting”, “processing” and “outputting”. Thus, by collectively regarding “inputting”, “processing”, and “outputting” as “conversion”, a filter is a software component (part) that realizes a single “conversion”. It is to be noted that each filter is independent from the others. In other words, there is basically no dependency (calling relationship) among the filters. Therefore, a function(s) of the MFP 1 can be added (installed) and deleted (uninstalled) in units of filters.

In FIG. 1, the function realizing section 30 includes plural filters (301-306, and a filter managing part 330 for managing the plural filters. The filter managing part 330 is for managing a function of a filter (filter function) and an object for realizing the function (filter function object) in correspondence with each of the below-described filters.

More specifically, the function realizing section 30 has filters for realizing an inputting function such as a reading filter 301, a stored document read-out filter 302, a mail receiving filter 303, a facsimile receiving filter 304, a PC document receiving filter 305, and a reporting filter 306.

The reading filter 301 is for controlling the reading of image data conducted by a scanner and outputting the read image data. The stored document read-out filter 302 is for reading out document data (image data) stored in a storage apparatus in the MFP 1 and outputting the read out data. The mail receiving filter 303 is for receiving electronic mail and outputting data included in the electronic mail. The facsimile receiving filter 304 is for controlling reception of facsimile data and outputting the received facsimile printout data. The reporting filter 306 is for forming various data (e.g., settings of the MFP 1, history data) into, for example, a table format and outputting the formed data.

The function realizing section 30 also has filters for realizing a processing function such as a document processing filter 311 and a document converting filter 312. The document processing filter 311 is for performing a predetermined image conversion process (e.g., aggregation, expansion, reduction) on input data and outputting the processed data. The document converting filter 312 is for converting the data format of image data. For example, the document converting filter 312 performs rendering, that is, converts input PostScript data to bitmap data and outputs the converted data.

The function realizing section 30 also has filters for realizing an outputting function such as a printing filter 321, a document storage registering filter 322, a mail transmitting filter 323, a facsimile transmitting filter 324, a PC document transmitting filter 325, and a preview filter 326.

The printing filter 321 is for outputting (printing) input data to a plotter. The document storage registering filter 322 is for storing input data in a storage apparatus (e.g., hard disk apparatus) of the MFP 1. The mail transmitting filter 324 is for attaching input data to electronic mail and transmitting the electronic mail. The facsimile transmitting filter 324 is for transmitting input data by facsimile. The PC document transmitting filter 325 is for transmitting input data via a personal computer. The preview filter 326 is for displaying input data as a preview image on an operations panel (not shown) via the local UI part 11.

The device service section 40 includes parts (functions (lower level functions)) which are commonly used by respective filters of the function realizing section 30. The device service section 40 includes a data managing part 41. The data managing part 41 is for expressing various databases. The databases include, for example, a database in which user data is registered or a database in which document data/image data are stored.

The device section 50 includes a device controlling part for controlling each device included in the MFP 1.

### (Diagram of Function Configuration Related to Registration of Plug-Ins and Filters of MFP 1)

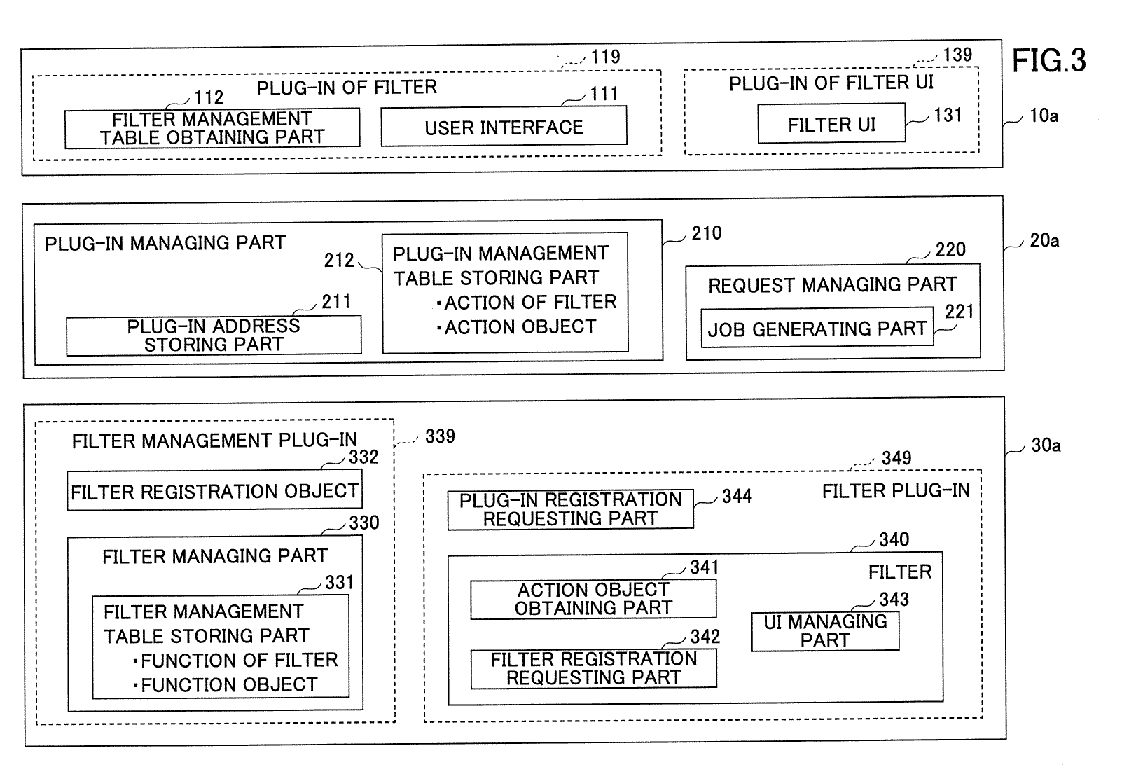

FIG. 3 is a schematic diagram showing exemplary function configuration related to registration of plug-ins of the MFP 1 and registration of filters included in the plug-ins of the MFP 1. That is, FIG. 3 shows exemplary the function configurations for a user-interface section 10a, a control section 20a, and a function realizing section 30a which correspond to the user-interface section 10, the control section 20, and the function realizing section 30 of the MFP 1 shown in FIG. 1.

The function realizing section 30a of FIG. 3 includes a plug-in for filter management (filter management plug-in) 339 and a plug-in for a filter(s) (filter plug-in) 349. The filter plug-in is a unit of software in a case where, for example, a filter is added to the MFP 1. The filter plug-in 349 includes a filter 340 and a plug-in registration requesting part 344. Alternatively, the filter plug-in 349 may include plural filters 344. Furthermore, the filter plug-in 349 may include a user-interface corresponding to the filter 340.

The filter 340 includes an operation object obtaining part 341 and a filter registration requesting part 342. Alternatively, the filter 340 may include a user-interface managing part (hereinafter also referred to as “UI managing part”) 343. Furthermore, the filter 340 may include a main processing part (not shown) for executing the function(s) of the filter 340.

The operation object obtaining part 341 is for obtaining an operation object of another filter(s) managed by the plug-in managing part 210. Examples of obtaining an operation object of other filters may be obtaining an execution program used for operating another filter or obtaining a program that sets instructions for operating another filter and outputs the instructions to the other filter. Thereby, a single filter can send a request for an operation to another filter or another part (component) via the plug-in managing part 210.

The filter registration requesting part 342 is for requesting registration of the filter 340 in the filter managing part 330 in a case where the filter plug-in 349 is added to the MFP 1 or in a case where the MFP 1 is activated. More specifically, the filter registration requesting part 342 requests registration of the function of the filter 340 and the function object corresponding to the function. The filter registration requesting part 342 requests registration of the filter 340 by obtaining a filter registration object 332. The obtaining of the filter registration object 332 is conducted by the operation object obtaining part 341.

The UI managing part 343 is for managing a user-interface corresponding to the filter 340. In FIG. 3, the user-interface corresponding to the filter 340 is included in a plug-in different from the filter plug-in 349. However, the image processing apparatus according to an embodiment of the present invention is not limited to such configuration and may have the user-interface corresponding to filter 340 provided in the filter 340.

The plug-in registration requesting part 344 is for requesting registration of the filter 340 in the plug-in managing part 210 in a case where the filter plug-in is added to the MFP 1 or a case where the MFP 1 is activated. More specifically, the plug-in registration requesting part 344 requests registration of the operation (action) of the filter 340 and the operation object corresponding to the operation (action). By using the operation object, other filters and parts can, for example, instruct the filter 340 to execute a process or set a process of the filter 340. For example, in a case where the filter 340 is installed by object oriented programming, the operation object may be configured as a public service.

The plug-in registration requesting part 344 may be included in the filter 340. With such configuration, even in a case where plural filters are included in a plug-in, the plug-in registration requesting part 344 can request registration of the operation of the filter and the operation object corresponding to the operation with respect to each filter.

The filter managing plug-in 339 includes the filter managing part 330. The filter managing plug-in 339 may include a filter registration object 332. The filter managing part 330 is for managing, for example, the functions of the filters included in the function realizing section 30a. The filter managing part 330 includes a filter management table storing part 331. The filter management table storing part 331 is for storing a filter management table therein. The function of the filter(s) 340 and the function object(s) corresponding to the function are registered in the filter management table of the filter management table storing part 331. Thus, by referring to the filter management table, the functions of the MFP 1 and the function objects corresponding to the functions can be recognized.

The filter registration object 332 is an operation object used when registering a filter (e.g., filter 340) in the filter managing part 330. The filter obtains the filter registration object 332 via the plug-in managing part 210, so that the filter can be registered in the filter managing part 330.

As shown in FIG. 3, the control section 20a includes the plug-in managing part 210 and the request managing part 220. The plug-in managing part 210 includes a plug-in address storing part 211 and a plug-in management table storing part 212. The plug-in address storing part 211 is for storing and managing the addresses of the plug-ins that are already added to the MFP 1. More specifically, the plug-in address storing part 211 stores the addresses of the plug-ins in correspondence with the name of corresponding plug-ins.

The plug-in management table 212 is for registering and managing operation of the filters in the function realizing section 30a and the operation object corresponding to the operation. The operation of a filter may be, for example, executing a process for realizing a function of a filter or determining the settings used for executing the process. Furthermore, the operation object may be, for example, a program that receives an instruction to execute the process and outputs the instruction to a function object that realizes a function corresponding to the process. Moreover, the operation object may be a program used for determining the settings (conditions) used when realizing a function of a filter.

The request managing part 220 is for selecting filters that realize an input request (e.g., request for executing a job from the user-interface section 10a) from the filters registered in the plug-in managing part 210 and conducting a process of connecting the selected filters. The request managing part 220 may also control the connecting process.

The user-interface section 10a includes a user-interface plug-in (hereinafter also referred to as “UI plug-in”) 119. The user-interface section 10a may also include a plug-in for the user-interface (UI) of a filter (hereinafter also referred to as “filter user-interface plug-in”) 139. The UI plug-in 119 is for realizing a user-interface. More specifically, the UI plug-in 119 according to this embodiment of the present invention is a local user-interface, such as an operation provided to the MFP 1. Alternatively, the UI plug-in 119 may be used in a communication server for displaying information on a client PC connected to the MFP 1 or receiving input from the client PC connected to the MFP 1.

The UI plug-in 119 includes a user-interface 111 and a filter management table obtaining part 112. The user-interface 111 is for controlling displaying of information on a display part (e.g., operations panel) or receiving instructions from an input part. The filter management table obtaining part 112 includes a part for obtaining the filter management table stored in the filter management table storing part 331. After all of the filters in the function realizing section 30a are registered in the filter management table, the filter management table obtaining part 112 obtains the filter management table from the filter management table storing part 112. In addition, in a case where a filter is added to the function realizing section 30a, the filter management table obtaining part 112 obtains the filter management table after the newly added filter is registered in the filter management table.

The filter UI plug-in 139 includes a UI 131 of a filter (hereinafter also referred to as “filter UI”). The filter UI 131 serves as a user-interface corresponding to one of the filters in the function realizing section 30a. The filter UI 131 includes a control part for receiving, for example, data to be displayed on a display screen of an operations panel and instructions input from the operations panel.

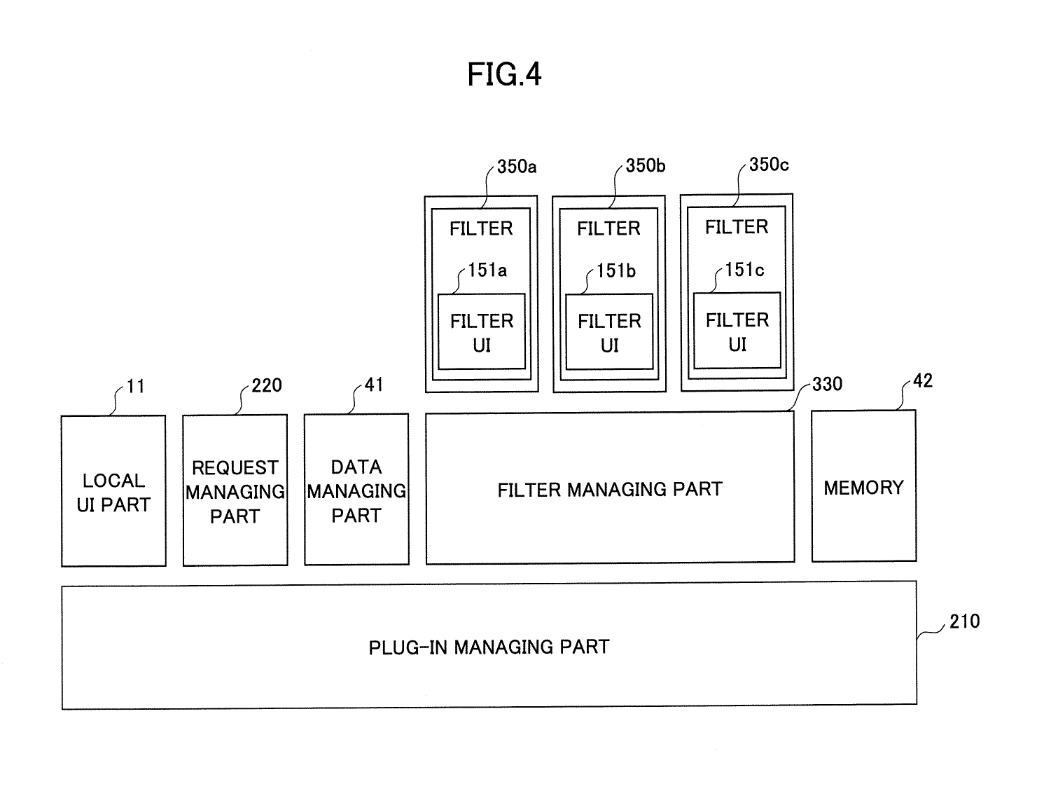

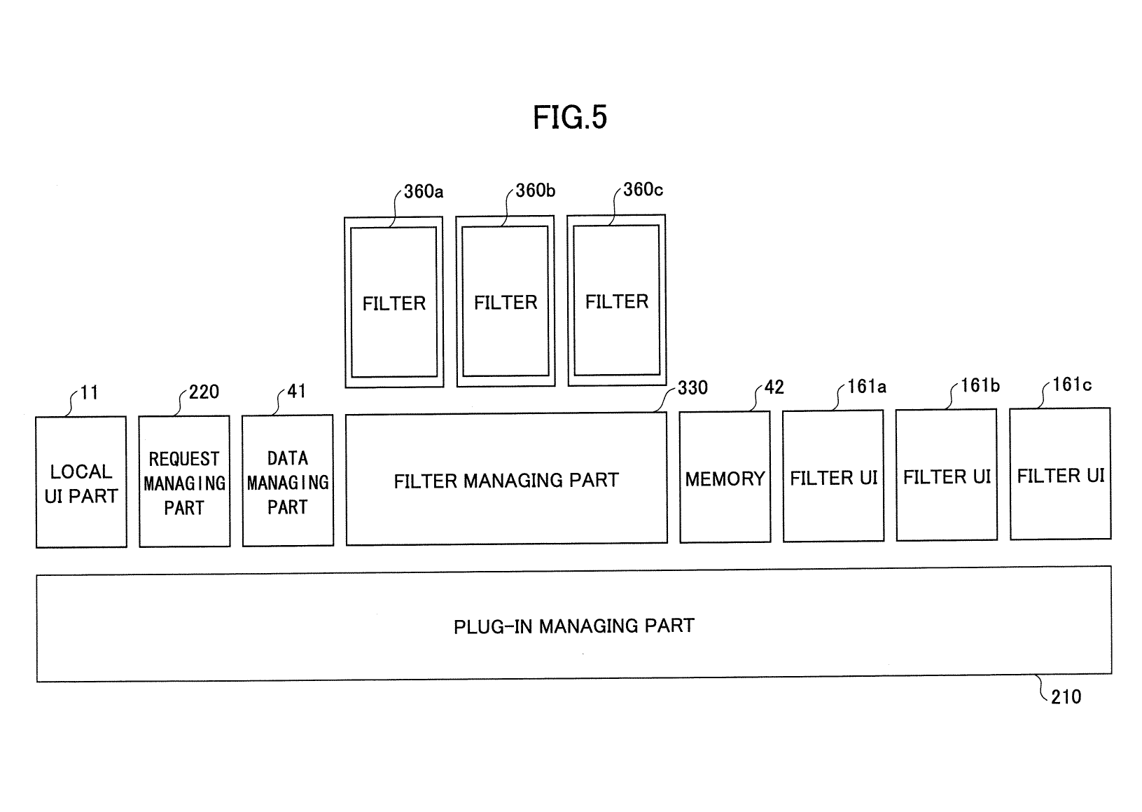

FIGS. 4 and 5 are schematic diagrams for describing the logical relationship between a filter and a filter UI.

FIG. 4 shows an exemplary case where a filter has a function of a user-interface corresponding to the filter. In FIG. 4, the plug-in managing part 210 registers each of the local UI part 11, the request managing part 220, the data managing part 41, the filter managing part 330, and a memory 42 as a plug-in and manages the registered plug-ins. Meanwhile, the filter managing part 330 registers the filters 350a-350c and manages the registered filters 350a-350c. Each of the filters 350a-350c includes a filter UI 151a-151c. Each filter UI 151a-151c is managed by a corresponding filter 350a-350c.

FIG. 5 shows an exemplary case where a filter and a user-interface corresponding to the filter are included in different plug-ins. The same as FIG. 4, the plug-in managing part 210 shown in FIG. 5 manages the local UI part 11, the request managing part 220, the data managing part 41, the filter managing part 330, and the memory 42. In addition, the plug-in managing part 210 manages the filter UI 161a-161c. Meanwhile, the filter managing part 330 registers filters 360a-360c and manages the filters 360a-360c. Each of the filters 360a-360c corresponds to the filter UI 161a-161c.

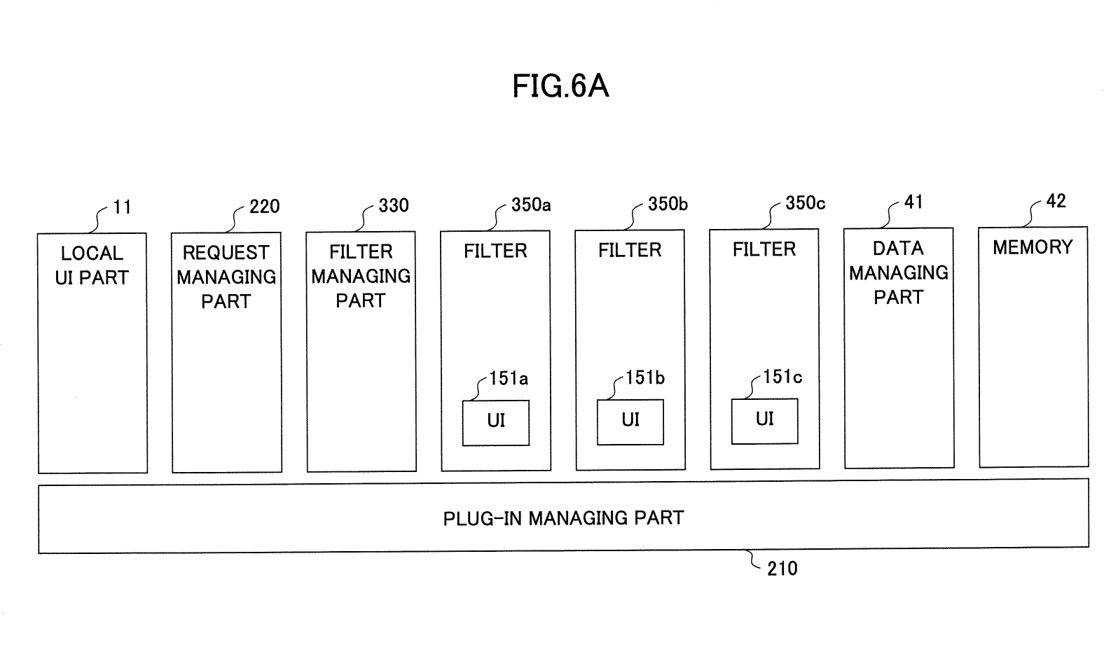

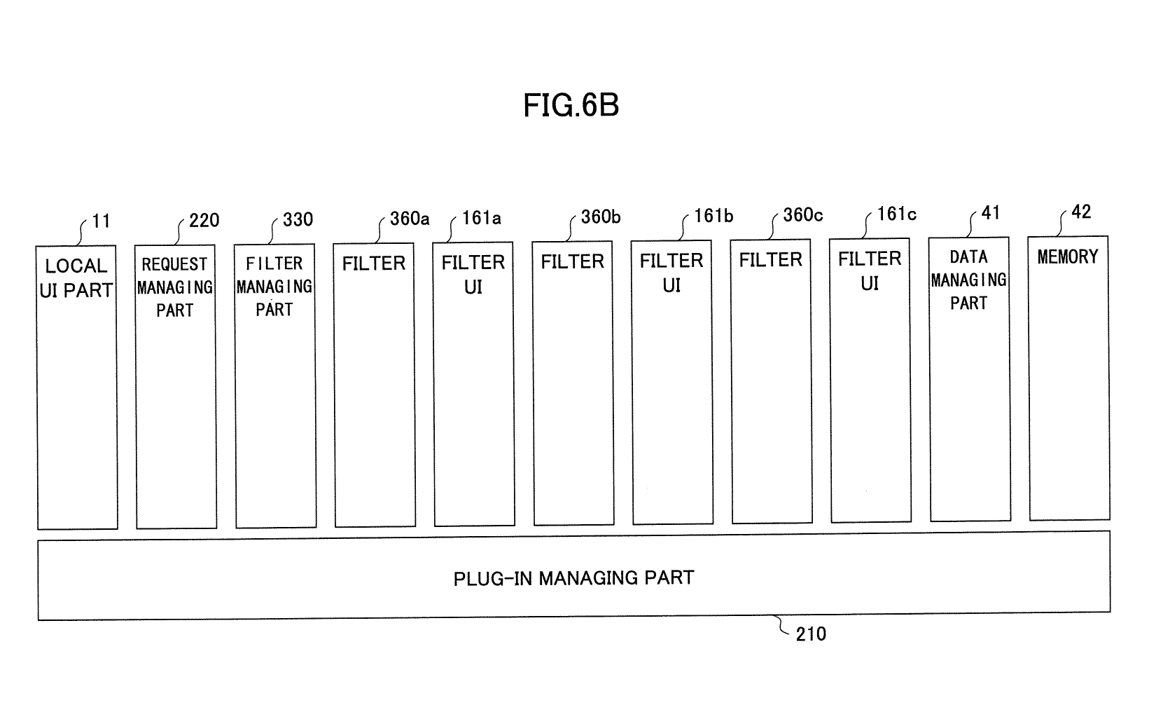

FIGS. 6A and 6B are schematic diagrams for describing the physical configuration of filters and filter user-interfaces (UI) according to an embodiment of the present invention. FIG. 6A shows the physical configuration of filters and filter UIs in the case shown in FIG. 4 in which the plug-in managing part 210 manages the filters 350a-350c. FIG. 6B shows the physical configuration of filters and filter UIs in the case shown in FIG. 6B in which the plug-in managing part manages the filters 360a-360c along with managing the filter UIs 161a-161c.

### (Operation where MFP 1 is Activated (Part 1))

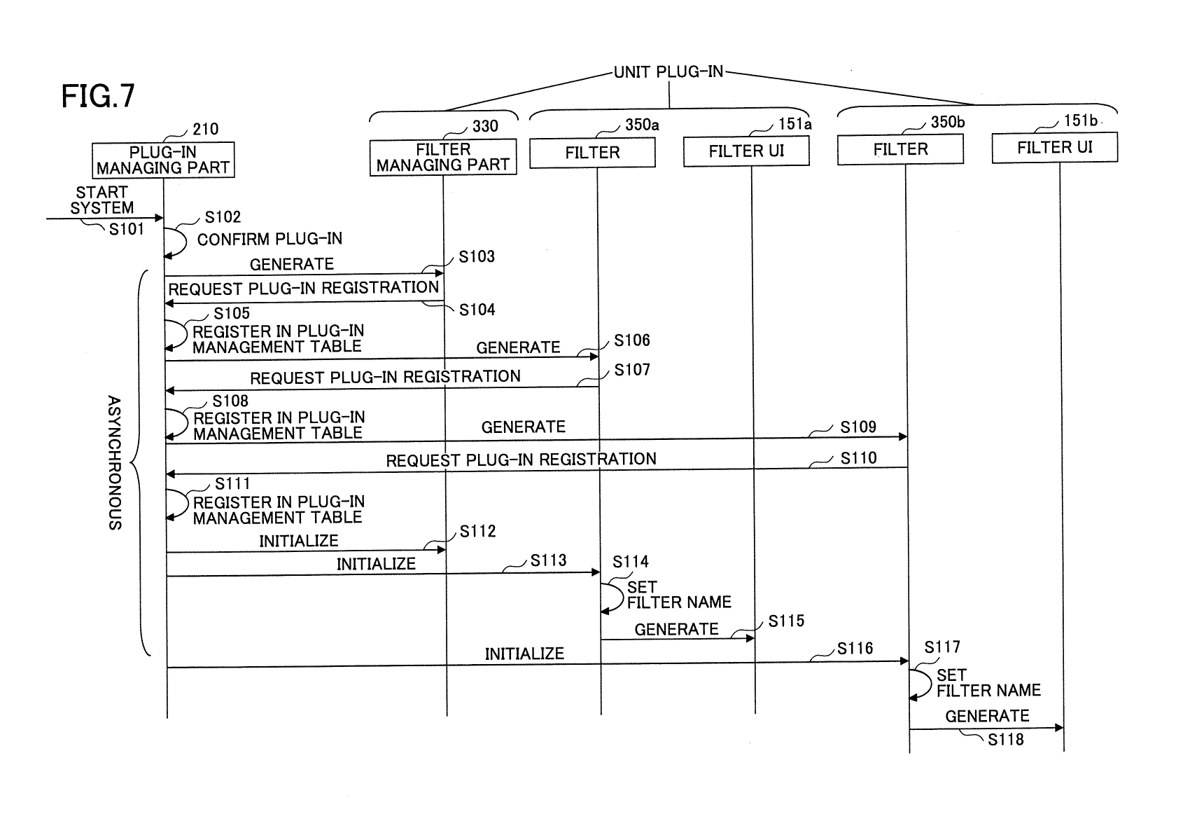

FIGS. 7-15 are diagrams for describing an operation in a case where the MFP 1 is activated (booted). In this case, filters and filter UIs are included in a single plug-in.

FIG. 7 is a sequence diagram showing an exemplary operation of registering a filter of a plug-in to the plug-in managing part 210 according to an embodiment of the present invention. In FIG. 7, first, an activation (boot) instruction is input to the plug-in managing part 210 upon applying power to the MFP 1 (Step S101). Then, the plug-in managing part 210 obtains a list of addresses stored in the plug-in address storing part 211 (Step S102).

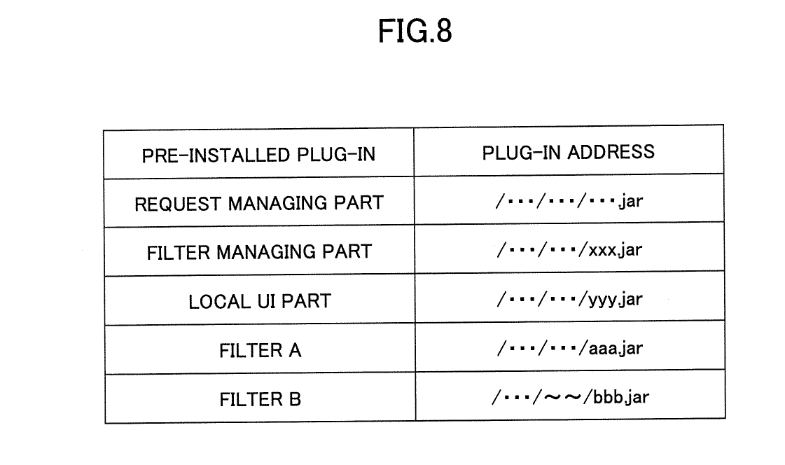

FIG. 8 is a list including plug-in names and plug-in addresses stored in the plug-in address storing part 211. In FIG. 8, the names of the plug-ins which are already added (installed) in the MFP 1 are listed in correspondence with the addresses where the plug-ins are stored. In the example shown in FIG. 8, the addresses, which the plug-ins are stored, are indicated with path names of files having an execution form of JAVA® in the file system of a storage device. Nevertheless, the image processing apparatus of the present invention is not limited to using the example shown in FIG. 8. For example, the plug-in may be a program written with a program language other than JAVA® and converted into another execution form. Furthermore, in a case where the plug-in is configured as a program, the place for storage may be, for example, an address of a sector in a storage device.

Then, the plug-in managing part 210 outputs an instruction to generate the filter managing part 330 (Step S103). According to the instruction, the filter managing part 330 is generated. It is to be noted that, such “generation of a part” refers to loading a program into a memory in a case where the part is configured as a program and refers to turning on the power of a device (apparatus) in a case where the part is configured as hardware.

Then, the filter managing part 330 outputs a plug-in registration request to the plug-in managing part 210 (Step S104). Such request for registering a plug-in including a part is to request an action of the part and an action object corresponding to the action. Then, the plug-in managing part 210 registers, for example, the action of the filter managing part 330 in the plug-in management table (Step S105).

Then, the plug-in managing part 210 outputs an instruction to generate a filter 350a (Step S106). It is to be noted that, such “generation of a filter” refers to loading a program to a memory in a case where the plug-in including the filter is configured as a program and refers to turning on the power of a device (apparatus) in a case where the plug-in including the filter is configured as hardware.

Then, the plug-in registration requesting part having the plug-in including the filter 350a outputs a plug-in registration request to the plug-in managing part 210 (Step S107). The registration request of a plug-in including a filter refers to requesting registration of an action of a filter and an action object corresponding to the filter. Then, the plug-in managing part 210 registers the action of the filter 350a and the action object corresponding to the action in the plug-in management table (Step S108).

Then, the plug-in managing part 210 outputs an instruction to generate a filter 350b. Accordingly, the filter 350b is generated (Step S109). Then, the plug-in registration requesting part having the plug-in including the filter 350b outputs a plug-in registration request to the plug-in managing part 210 (Step S110). Then, the plug-in managing part 210 registers the action of the filter 350b and the action object corresponding to the action in the plug-in management table (Step S111).

Then, the plug-in managing part 210 outputs an instruction to initialize a part (component) to the filter managing part 330. Accordingly, the filter managing part performs the initialization (Step S112). It is to be noted that “initialization” of a part (component) is to, for example, initialize the variable used when executing a program in a case where the part (component) is a program. Furthermore, “initialization” of a part (component) may also be to, for example, set the initial value inside a single program in a case where the part (component) is a program.

Then, the plug-in managing part 210 outputs an instruction to initialize the filter 350a to the filter 350a. Accordingly, the filter 350a initializes itself. (Step S113). It is to be noted that “initialization” of a filter is to, for example, initialize the variable used when executing a program in a case where the filter is a program. Furthermore, “initialization” of a filter may also be, for example, setting the initial value inside a single program in a case where the filter is a program.

Then, the filter 350a sets a filter name (Step S114). It is to be noted that “setting” a filter name is to set, for example, a name of a function (e.g., “printing”, “reading”, etc.). Then, the filter 350a outputs an instruction to generate a filter user-interface (UI) to the filter UI 151a. Accordingly, the filter UI 151a generates a user-interface of the filter 350a (Step S115). After the filter UI 151a is generated, the filter 350a outputs an instruction to initialize the generated UI to the filter UI 151a. Accordingly, the filter UI 151a performs the initialization (this step not shown in drawing).

Since the processes performed in the subsequent Steps S116 to S118 for the filter 350b are the same as those of Steps 113 to S115 for the filter 350a, further explanation thereof is omitted.

In the above-described Steps S101 to S118, a generating process, a plug-in registration requesting process, and a registering process by the plug-in managing part 210 are performed on each of the filter managing part 330, the filter 350a, and the filter 350b in this order. Alternatively, instead of performing the processes in this order, the processes may be performed asynchronously.

With the processes in Steps S101 to S118, a plug-in management table having the plug-in managing part 210 can be generated.

### (Information Output Upon Requesting Registration to Plug-In Managing Part)

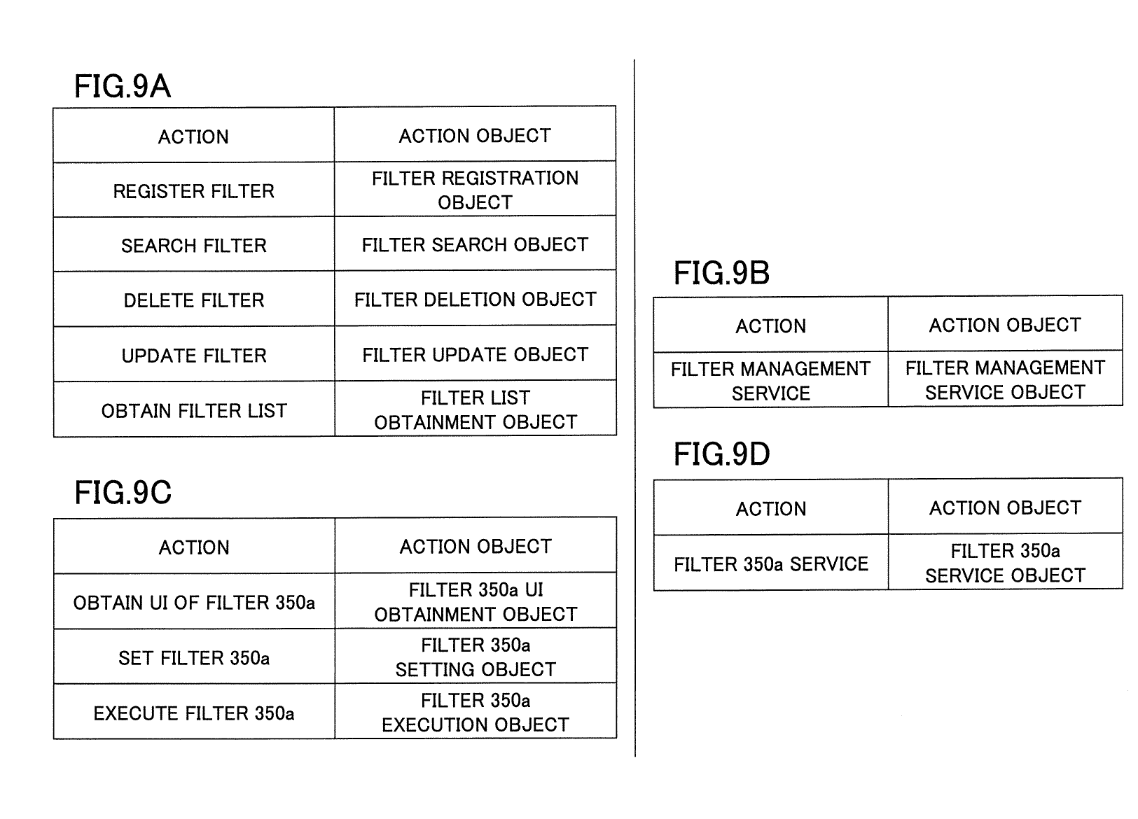

FIGS. 9A-9D show information (data) that is output upon requesting registration in the plug-in managing part. FIGS. 9A and 9B show an example of a table which is output from the filter managing part 330 to the plug-in managing part 210 when the filter managing part 330 request registration in Step S104 of FIG. 7. In FIG. 9A, the actions of the filter managing part 330 which include, for example, “registration of filter”, “searching of filter”, “deletion of filter”, “update of filter”, and “obtaining of filter list” and the action objects corresponding to the actions of the filter managing part 330 are output to the plug-in managing part 210.

In FIG. 9B, in order to receive actions for the filter managing part 330 (reception), the actions of the “filter managing service” and the action objects corresponding to the actions are output upon requesting registration. In a case where an action(s) shown in FIG. 9B is registered by the plug-in managing part 210, the parts (components) which output instructions to the filter managing part 330 input an instruction (e.g., “register”, “search”, “delete”, “update”, or “obtain list”) is input to the filter managing service, to thereby enable the filter managing part 330 to perform the instructed action.

FIGS. 9C and 9D show an example of a table which is output from the plug-in registration requesting part having a plug-in including the filter 350a to the plug-in managing part 210 when the filter 350a request registration in Step S107 of FIG. 7. In FIG. 9C, actions of the filter 350a which include, for example, “obtaining UI of filter 350a”, “setting of filter 350a”, and “execution of filter 350a” and the action objects corresponding to the actions of the filter 350a are output to the plug-in managing part 210.

In FIG. 9D, in order to receive actions for the filter 350a (reception), the actions of the “filter 350a service” and the action objects corresponding to the actions are output upon requesting registration. In a case where an action(s) shown in FIG. 9D is registered by the plug-in managing part 210, the parts (components) which output instructions to the filter 350a input an instruction (e.g., “obtain UI”, “set”, “execute”,) is input to the filter 350a service, to thereby enable the filter 350a to perform the instructed action.

Instead of outputting the action object upon requesting registration, an address of the action object, a name of the action object, or a specification of a control command with respect to the action object may be output.

### (Example of Plug-In Management Table)

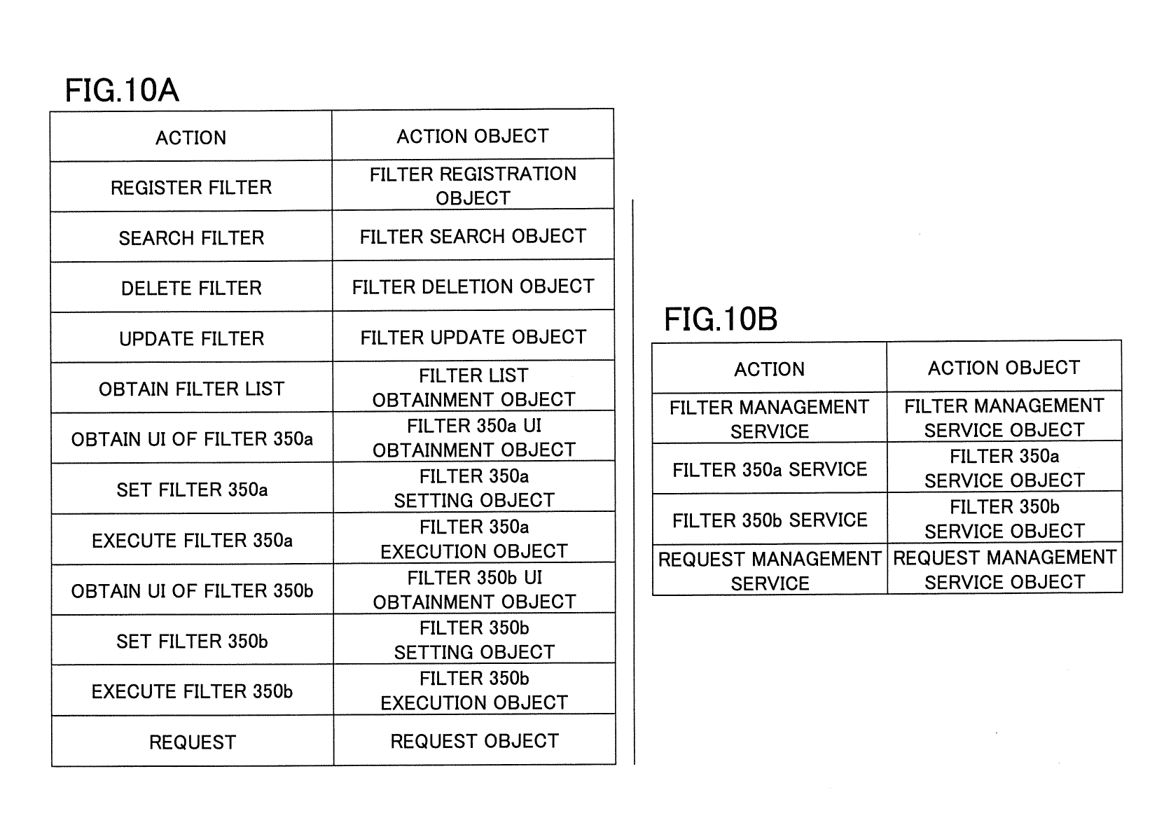

FIGS. 10A and 10B show examples of a plug-in management table stored by the plug-in management table storing part 212 of the plug-in management part 210. FIG. 10A shows an example of a plug-in management table indicative of actions of filters and parts (components) in a case where the table shown in FIG. 9A or 9C is registered. FIG. 10B shows an example of a plug-in management table registering a service(s) for receiving an action corresponding to each filter and part (component) in a case where the table shown in FIG. 9B or 9D is registered.

### (Example of Sequence where a Filter is Registered in the Filter Managing Part 330)

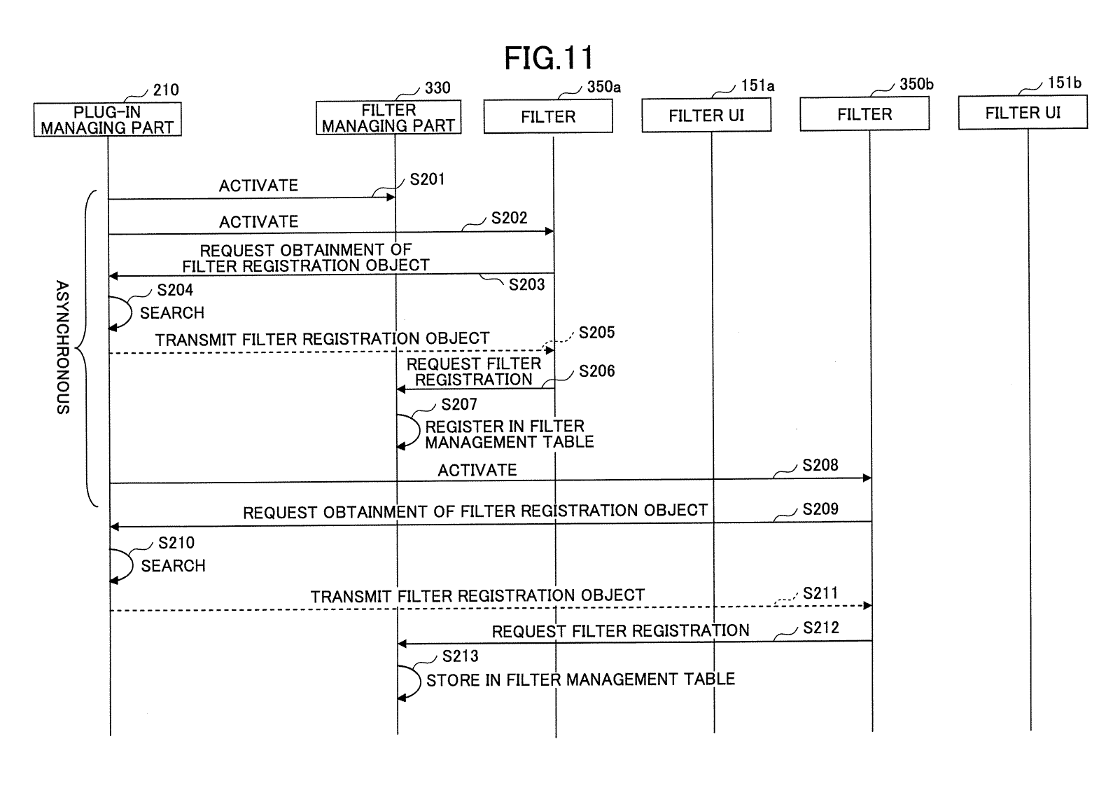

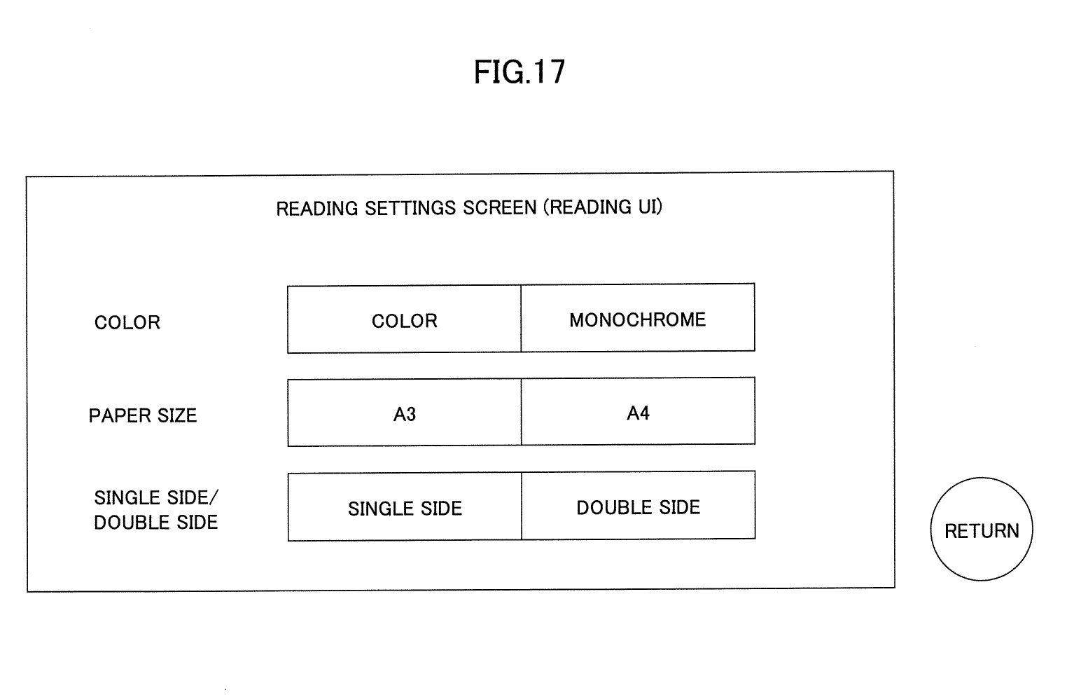

FIG. 11 is a sequence diagram showing an example of registering a filter(s) in the filter managing part 330. Although the processes shown in FIG. 11 are usually executed after the processes of Steps S101 through S118 of FIG. 17, the processes shown in FIG. 11 are to be executed at least after the filter managing part 330 is registered in the plug-in management table. First, the plug-in managing part 210 outputs an activation instruction to the filter managing part 330. Accordingly, the filter managing part 330 is activated (Step S201). It is to be noted that “activation” of a part (component) is to allow the part (component) to set the variable of another part (component) in the MFP 1 by providing information of an action of the other part (component) or filter in a case where the part is a program.

Then, the plug-in managing part 210 outputs an activation instruction to the filter 350a. Accordingly, the filter 350a is activated (Step S202). It is to be noted that “activation” of a filter is to allow the filter to set the variable of another part (component) in the MFP 1 by providing information of an action of the other part (component) or filter in a case where the part is a program.

Then, the filter 350a outputs a request for obtaining a filter registration object to the plug-in managing part 210 (Step S203). Then, the plug-in managing part 210 searches for the filter registration object from the plug-in management table stored in the plug-in management table obtaining part 212 of the plug-in managing part 210 (Step S204). Then, the plug-in managing part 210 transmits the filter registration object to the filter 350a (Step S205).

Then, the filter registration requesting part of the filter 350a outputs a request for registering the filter 350a based on the filter registration object to the filter managing part 330 (Step S206). The request for registering a filter (filter registration request) includes requesting registration of a function of a filter and a function object corresponding to the function.

Then, the filter management table storing part 331 of the filter managing part 330 registers the filter 350a to the filter management table and begins management of the filter 350a (Step S207). The registration of a filter (filter registration) includes registering a function of a filter and a function object corresponding to the function.

With the processes of Steps S202 to S207, the filter 350a is activated and is registered in the filter management table.

Since the processes performed in the subsequent Steps S208 to S213 for the filter 350b are the same as those of Steps S202 to S207 for the filter 350a, further explanation thereof is omitted.

In the above-described Steps S202 to S213, an activating process, a filter registration object obtainment requesting process, a filter registration object searching process by the plug-in managing part 210, a filter registration object obtaining process, a filter registration requesting process, and a filter registration process by the filter managing part 330 are performed by the filter 305a and the filter 305b in this order. Alternatively, instead of performing the processes in this order, the processes may be performed asynchronously.

### (Example of Filter Management Table)

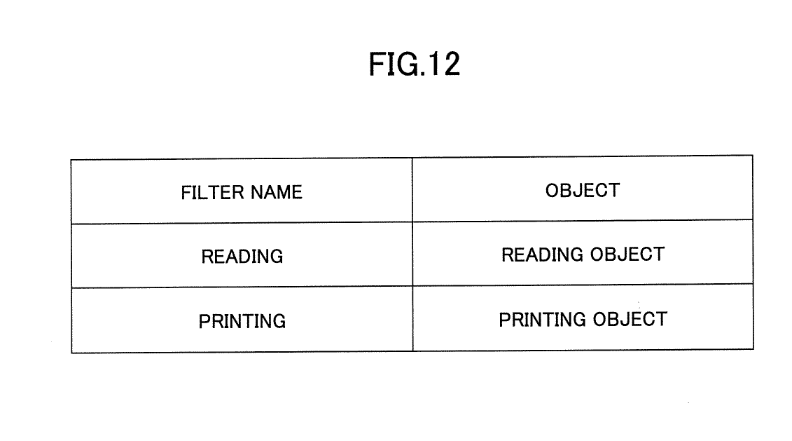

FIG. 12 shows an example of a filter management table. In FIG. 12, functions of filters such as “reading” and “printing” are registered together with objects corresponding to the functions such as “reading object” and “printing object”.

### (Example of Sequence of Registering a Local UI Part and a Request Managing Part in the Plug-In Managing Part 210)

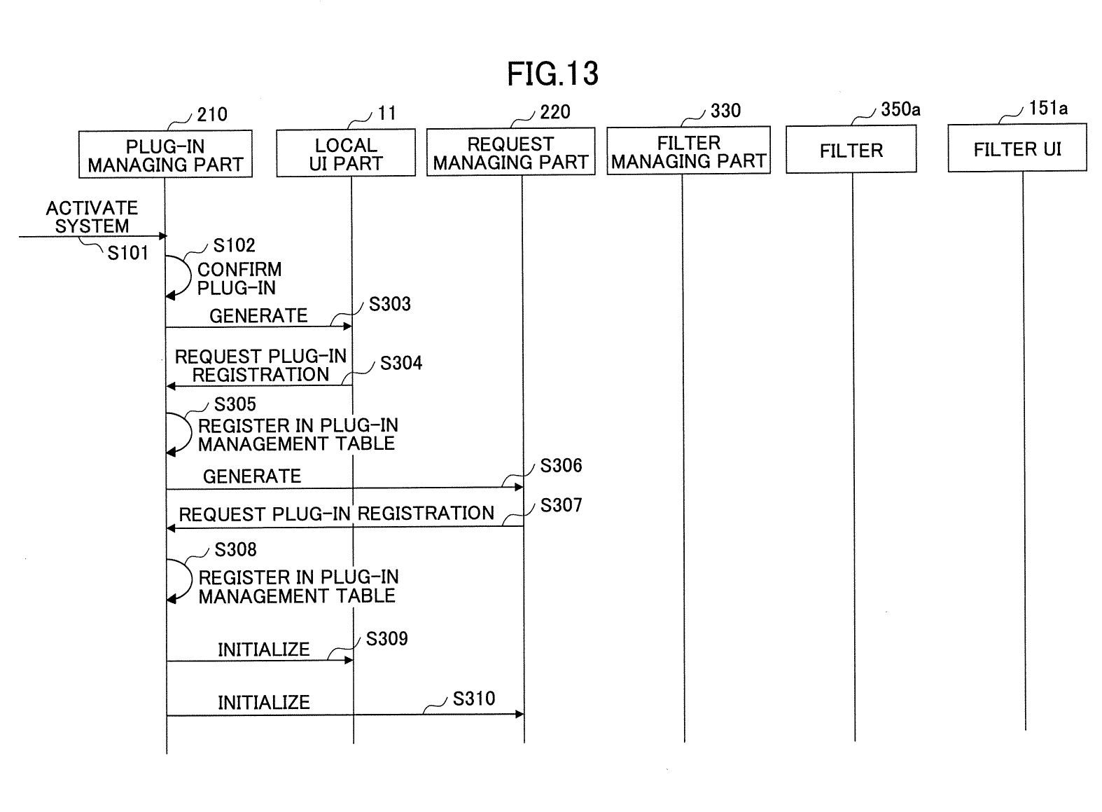

FIG. 13 is a sequence diagram showing an operation of registering the actions of the local UI part 11 and the request managing part 220 in the plug-in managing part 210. First, power is supplied to the MFP 1 (Step S101). Then, the plug-in managing part 210 obtains a list of plug-ins for confirming a plug-in(s) (Step S102). Then, in the subsequent Steps S303 to S310, the local UI part 11 and the request managing part 220 perform a generating process, a plug-in registration requesting step, a registration step by the plug-in managing part 210, and an initialization process. Since the processes performed by the local UI part 11 and the request managing part 220 are the same as those performed by the filter managing part 330 in Steps 103 to S105 and Step S112, further explanation thereof is omitted.

In the above-described Steps S303 to S310, the processes of the local UI part 11 and the request managing part 220 are performed in the order shown in FIG. 13. Alternatively, regardless of the order of the processes between the local UI part 11 and the request managing part 220 or the order of processes of Steps S103 to S118 of FIG. 7, the processes may be performed asynchronously.

### (Example of the Local UI Part 11 Obtaining the Filter Management Table)

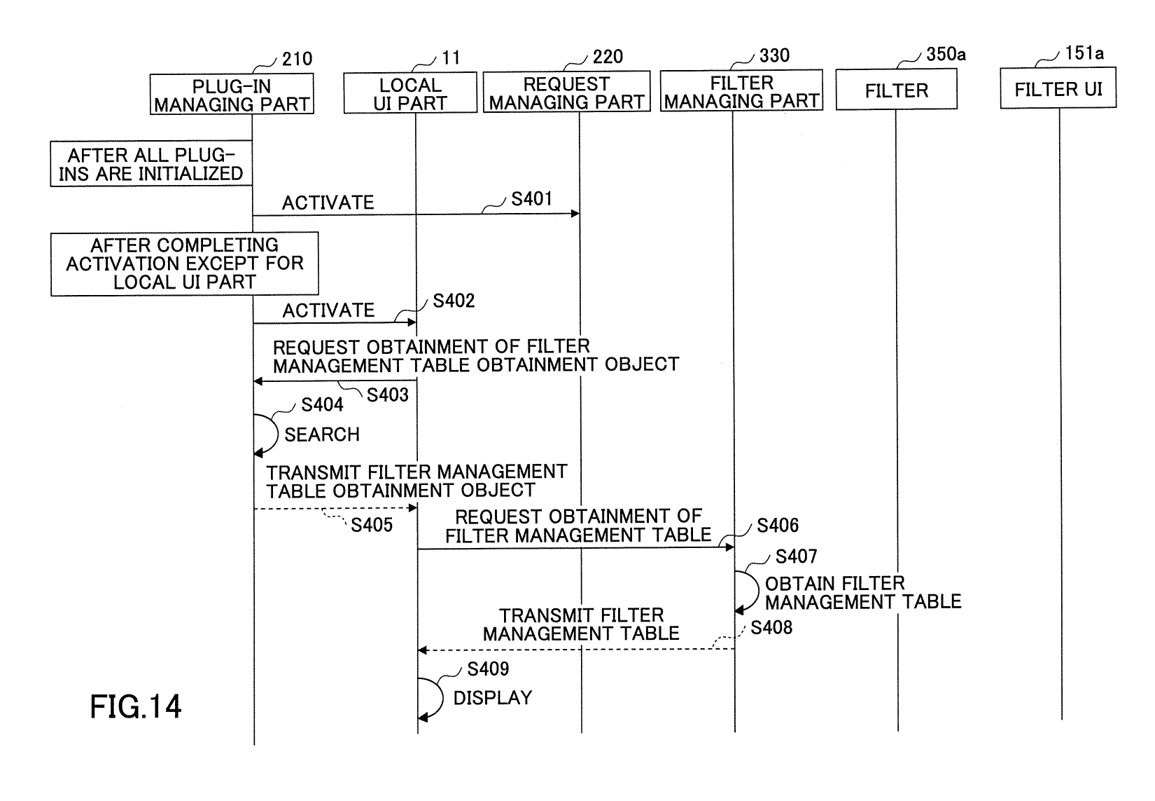

FIG. 14 is a sequence diagram showing an example of activation the local UI part 11 and the request managing part 220 and obtainment of the filter management table by the local UI part 11. In FIG. 14, the processes in Steps S401 to S409 are performed after all of the plug-ins in the MFP 1 are initialized.

In Step S401, the plug-in managing part 210 outputs an activation instruction to the request managing part 220. The activation instruction from the plug-in managing part 210 includes the plug-in managing table stored in the plug-in management table storing part 212. Thereby, the request managing part 220 can obtain all of the information (data) of the actions of the plug-ins in the MFP 1 and the objects corresponding to the actions.

Then, in Steps S402 to S409, the local UI part 11 is activated and the filter management table is obtained. The processes in Steps S402 to S409 are to be executed after other plug-ins and parts (components) except for the plug-in in the user-interface part (e.g., local UI part 11) of the user-interface section 10 are activated and the filter management table storing part 331 of the filter managing part 330 obtains the functions of the other plug-ins and parts (components) and objects corresponding to the functions. Thereby, the user-interface part such as the local UI part 11 can obtain and display all of the data related to the functions of the MFP 1.

First, the plug-in managing part 210 outputs an activation instruction to the local UI part 11. Accordingly, the local UI part 11 is activated (Step S402). Then, the local UI part 11 outputs a request for obtaining a filter management table obtainment object to the plug-in managing part 210 (Step S403). Then, the plug-in managing part 210 searches for a filter management table obtainment object registered in the plug-in management table storing part 212 (Step S404).

Then, the plug-in managing part 210 transmits the filter management table obtainment object to the local UI part 11 (Step S405). Then, the filter management table obtaining part 112 of the local UI part 11 outputs a request for obtaining a filter management table to the filter managing part 330 (Step S406).

Then, the filter managing part 330 obtains the filter management table in the filter management table storing part 331 (Step S407). Then, the filter managing part 330 transmits the filter management table to the local UI part 11 (Step S408).

Then, the local UI part 11 outputs and displays an operation screen (control screen) of the MFP 1 to a display apparatus (e.g., operations panel) based on the filter management table obtained in Step S408.

Although processes of a user-interface is described by using an example of the local UI part 11 of FIGS. 13 and 14, processes of generating a display on a client PC can be easily understood from FIGS. 13 and 14.

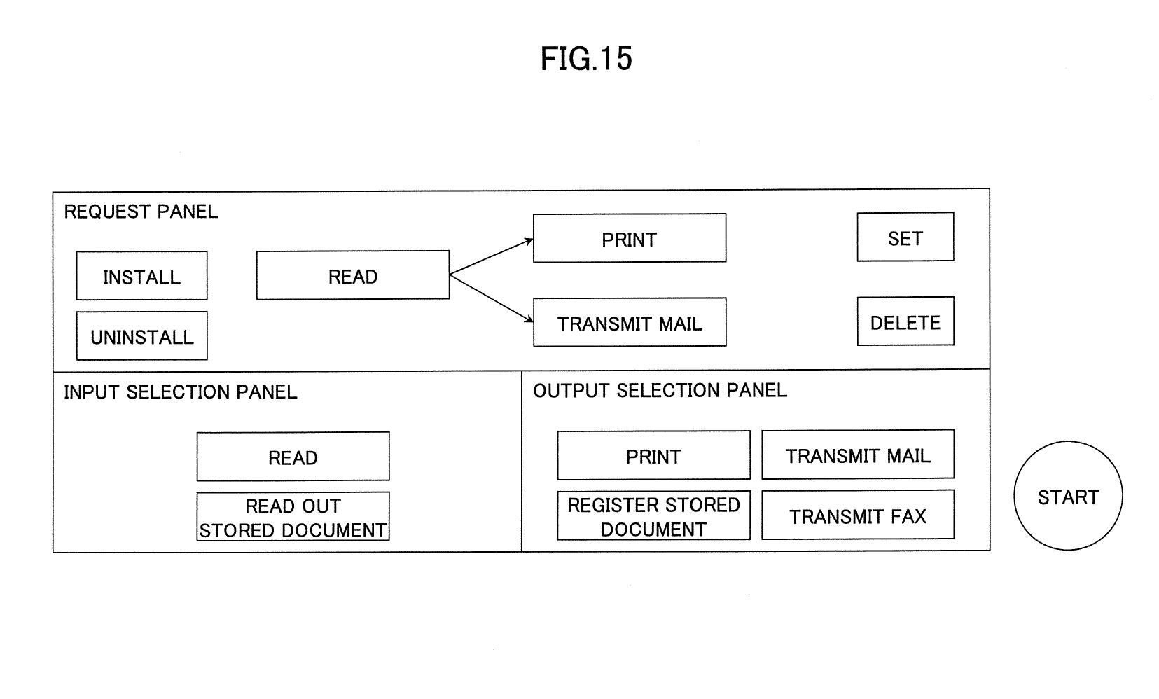

FIG. 15 shows an example of a control panel of the MFP 1, that is, a screen displayed on an operations panel of the MFP 1. The control panel shown in FIG. 15 has three areas including a “request panel”, an “input selection panel”, and an “output selection panel”. The request panel is for displaying processes executed by the MFP 1. In the example shown in FIG. 15, a process of reading an image (reading process), a process of printing out the read image (printing process), and a process of transmitting electronic mail (mail transmission process) are displayed. The request panel also displays buttons such as “install”, “uninstall” and “set”.

The input selection panel is for enabling selection of functions for inputting an image to the MFP 1. The input selection panel in this example displays buttons such as “read” and “read out stored document”. The “read” button is for obtaining image data from a scanner. The “read out stored document” button is for reading out and obtaining image data stored in a storage device of the MFP 1.

The output selection panel is for enabling selection of functions for outputting an image from the MFP 1. The output selection panel in this example displays buttons such as “print”, “register stored document”, “transmit mail”, and “transmit fax”. The “print” button is for outputting data from a plotter. The “register stored document” button is for storing image data to a storage device of the MFP 1. The “transmit mail” button is for attaching an image data file to electronic mail and transmitting the electronic mail. The “transmit fax” button is for transmitting an image by facsimile.

The functions corresponding to the buttons displayed on the input selection panel and the output selection panel are associated in correspondence with each filter of the filter realizing section 30a based on the filter management table obtained in Step S408 of FIG. 14.

### (Operation of MFP 1 Based on Input to Local UI Part 11 (Filter Setting Process))

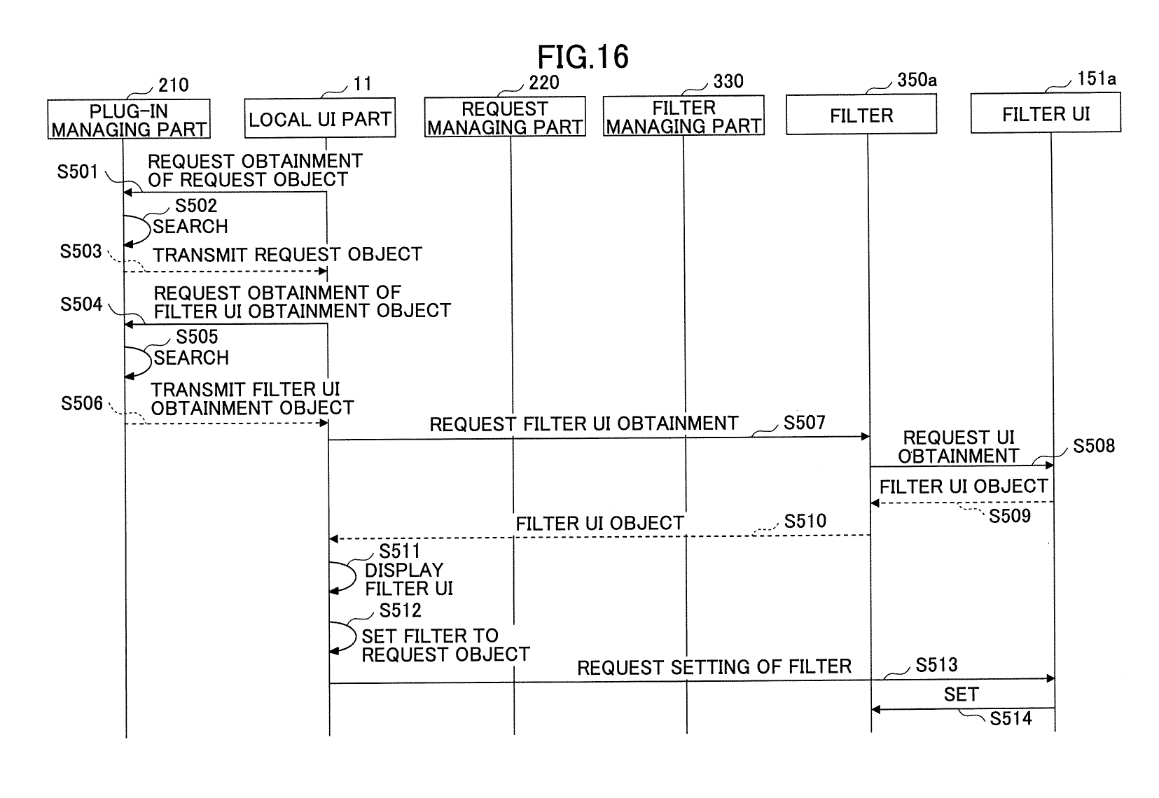

FIGS. 16 to 18 are for describing an exemplary sequence of processes in a case where the MFP 1 (activated by the processes shown in FIGS. 7-15) executes a job based on input to the local UI part 11.

FIG. 16 is a sequence diagram showing processes of setting a filter for realizing a job. More specifically, FIG. 16 is for describing an exemplary process of displaying the local UI part 11 on an operations panel by inputting data to operations panel for setting the filter 350a.

Steps S501 to S503 of FIG. 16 show a sequence of processes for preparation of receiving instructions input from an operations panel in a case where the display of the operations panel is in its initial state. In Step S501, the local UI part 11 outputs a request for obtaining a request object to the plug-in managing part 210. The request object is an action object for receiving a request (e.g., instructions) from the user of the MFP 1 via the user interface, selecting a function(s) for realizing the request, and executing the request.

In Step S502, the plug-in managing part 210 searches for the request object from the action objects stored in the plug-in table storing part 212. In Step S503, the plug-in managing part 210 transmits the request object to the local UI part 11.

Since the processes in Steps S501 to S503 are executed in a case where the display of the operations panel is in its initial state, these processes may be omitted, for example, in a case where a control screen is already displayed on the operations panel and the request object is already obtained by the local UI part 11.

The processes in the following Steps S504 to S511 are for obtaining the user-interface of a filter (filter UI) 151a and displaying the filter UI 151a on the operations panel. For example, the processes may be executed in a case of selecting a filter from the control screen of FIG. 15 and pressing the “set” button.

In Step S504, the local UI part 11 transmits a request for obtaining a filter UI obtainment object to the plug-in managing part 210. In Step S505, the plug-in managing part 210 searches for a filter UI obtainment object corresponding to the requested filter UI from the action objects stored in the plug-in table storing part 212. In Step S506, the plug-in managing part 210 transmits the filter UI obtainment object to the local UI part 11.

In Step S507, the local UI part 11 transmits a request for obtaining the filter UI to the filter 350a based on the filter UI obtainment object obtained in Step S506. In Step S508, the filter 350a outputs a UI obtainment request to the filter UI 151a. In Step S509, the filter UI 151a outputs a filter UI object to the filter 350a. In Step S510, the filter 350a outputs a filter UI object to the local UI part 11. In Step S511, the local UI part 11 displays a screen of the filter UI obtained in Step S510.

FIG. 17 shows an example of a screen of a filter UI. In this example, the filter of the filter UI corresponds to a “reading” function. In FIG. 17, various conditions (e.g., “color mode”, “paper size”, “single/double side”) for executing the reading function can be set by pressing the corresponding buttons on the screen. After the conditions are selected by pressing the corresponding buttons, the display of the operations panel returns to a state shown in FIG. 15 by pressing the “return” button. Then, the “reading” filter is set in accordance with the selection.

The processes of Steps S512 to S514 of FIG. 16 are for setting a filter (in this example, filter 350a). In Step S512, the local UI part 11 sets the filter 350a to the request object obtained in Step S503. Accordingly, input (data input) from the operations panel can be processed as settings requested to the filter 350a.

In Step S513, after settings of the filter 350a is selected by the buttons on the operations panel, the local UI part 11 outputs a request for setting the filter 350a to the filter UI 151a according to the content selected on the operations panel. It is to be noted that Step S513 may be executed after a button (not shown) indicating completion of selection of buttons (“set”) is depressed. In Step S514, the filter UI 151a outputs setting conditions (content) to the filter 350a. Thereby, the filter 350a is set according to the setting conditions (content) obtained from the filter UI 151a.

### (Operation of MFP 1 Based on Input to Local UI Part 11 (Filter Executing Process))

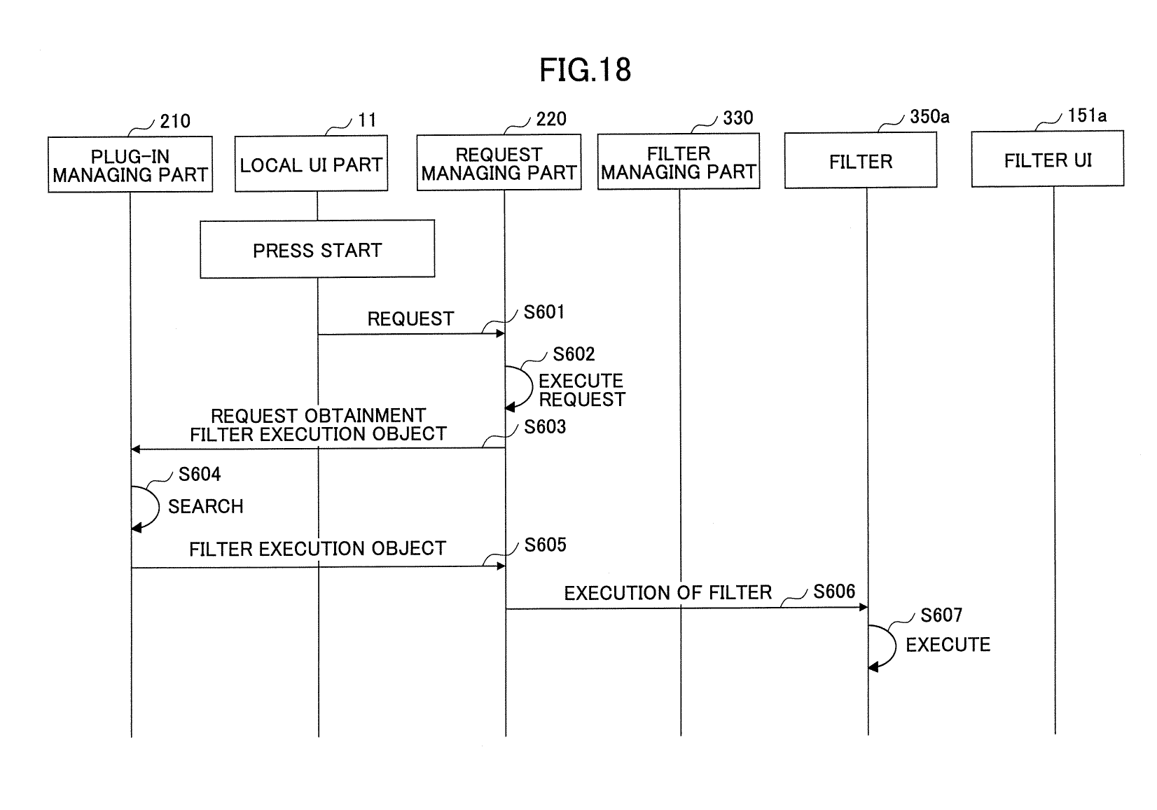

FIG. 18 is a sequence diagram showing processes of the MFP 1 realizing the function of the filter 350a based on instructions input to the local UI part 11 via the operations panel, for example. In FIG. 18, the MFP 1 realizes the function of the filter 350a when the user presses “start” button on the control screen of FIG. 15.

In Step S601, after the “start” button on the operations panel is pressed, the local UI part 11 outputs a request for starting an operation of realizing the function of the filter 350a. In Step S602, the request managing part 220 selects the filter(s) corresponding to a job and the settings of each filters based on the content of the request obtained from the local UI part 11.

In Step S603, the request managing part 220 transmits a request for obtaining an execution object of the filter (filter execution object) selected in Step S602. In Step S604, the plug-in managing part 210 searches for the execution object of the filter requested in Step S603.

In Step S605, the plug-in managing part 210 transmits the filter execution object to the request managing part 220. In Step S606, the request managing part 220 outputs an execution request to the filter 350a based on the filter execution object obtained in Step S605. In Step S607, the filter 350a executes its function based on the execution request obtained in Step S606.

With the processes in Step S601 to S607, operation of realizing the function(s) of the MFP 1 can be performed according to instructions input to the operations panel by the user.

### (Example of Installing Filter Including Filter UI)

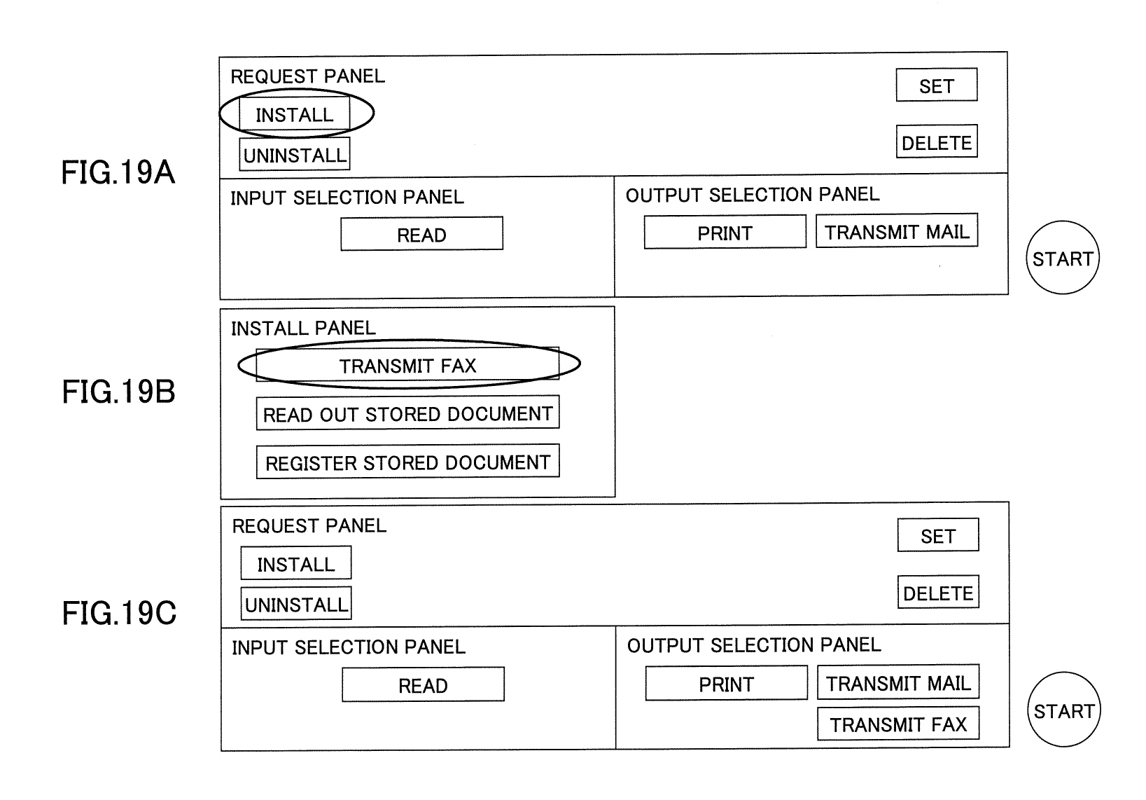

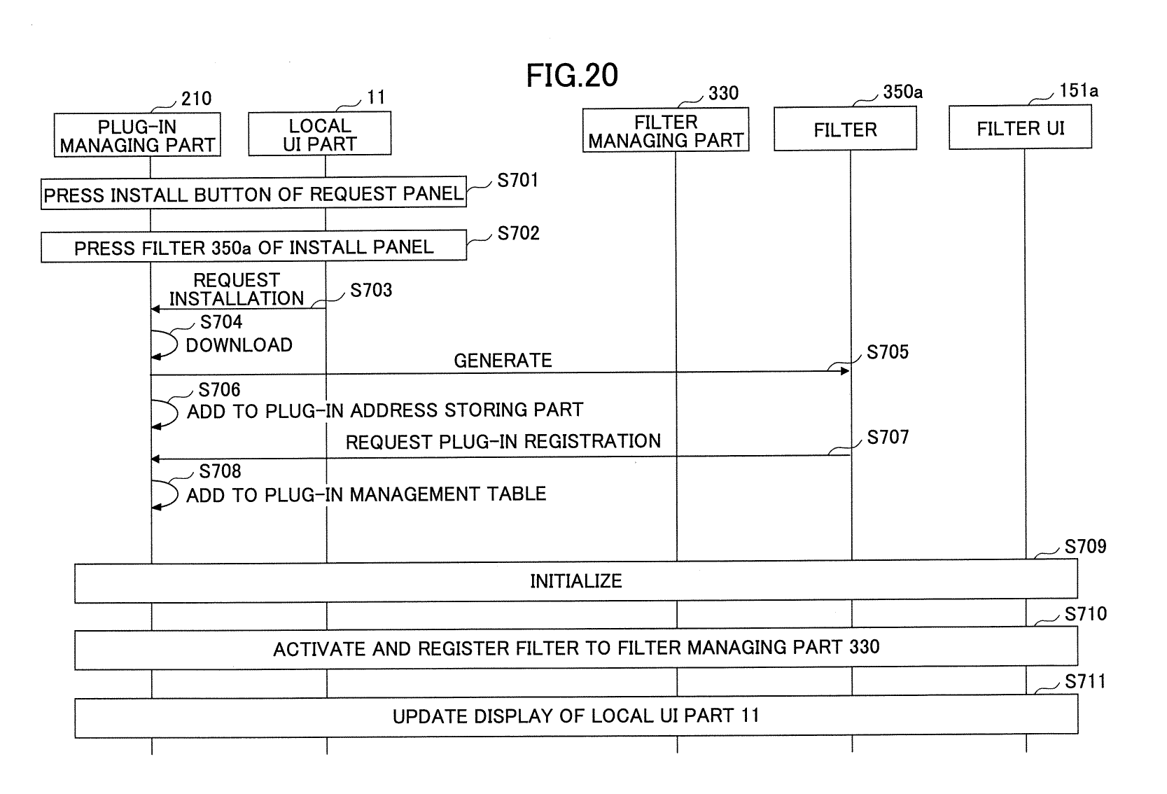

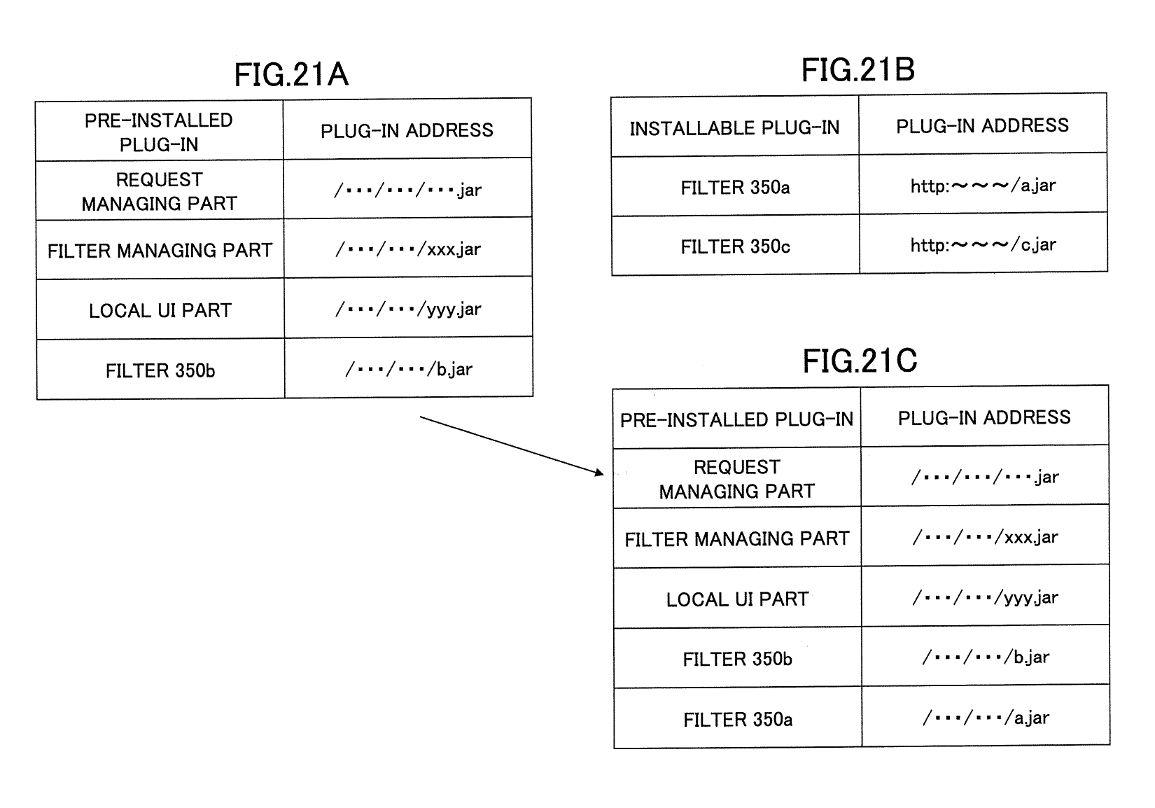

FIGS. 19A to 21C are schematic diagrams for describing a case of adding a filter including a filter UI to the MFP 1. More specifically, FIGS. 19A-19C show examples of a screen displayed on an operations panel when adding a filter including a filter UI to the MFP 1. FIG. 20 is a sequence diagram showing an example of a process of adding a filter including a filter UI to the MFP 1. FIGS. 21A-21C show the content of the plug-ins managed by the plug-in address storing part 211.

FIG. 19A shows a case where an action “install” is selected from an operations panel. When “install” is selected, the display of the operations panel switches to the screen shown in FIG. 19B. FIG. 19B shows a list indicating functions that can be added to the MFP 1. The MFP 1 may obtain such list by communicating with an outside server (not shown) via the communication server part 12. Furthermore, the MFP 1 may obtain a list of functions of filters which are stored in a storage device of the MFP 1 but not yet added as functions of the MFP 1. The example of FIG. 19B shows a case where the user selects a “fax transmission” function as the function to be added to the MFP 1. When the user selects the function to be added as shown in FIG. 19B, a process for installing a filter is started.

In Step S701 of FIG. 20, the button “install” on the operations panel is selected by the user. Accordingly, the display of the operations panel is switched to the screen shown in FIG. 19B. In Step S702, the user selects the filter displayed on the operations panel and presses a button commanding to start installation.

In Step S703, the local UI part 11 outputs an installation request to the plug-in managing part 210. In Step S704, the plug-in managing part 210 downloads a plug-in corresponding to the filter to be installed. The plug-in managing part 210 may download the plug-in from an outside server (not shown) via the communication server part 12 or obtain the plug-in from a storage device (not shown) of the MFP 1. Although this example describes the plug-in as a program, the plug-in may alternatively be an apparatus (device). In a case where the plug-in is an apparatus (device), the plug-in may be added by connecting the apparatus (device) to the MFP instead of downloading.

In Step S705, the plug-in managing part 210 outputs an instruction for generating a filter 350a (generation of filter) to the filter 350a. In Step S706, the plug-in managing part 210 stores the address of the plug-in including the filter 350a in the plug-in address storing part 211.

In Step S707, the filter 350a outputs a request for registering the plug-in including the filter 350a to the plug-in managing part 210. In Step S708, the plug-in managing part 210 registers the action of the filter 350a and the action object corresponding to the action in the plug-in management table.

In Step S709, the filter 350a is initialized. Since the processes in the initialization of Step S709 are the same as those in Steps S113 to S115 of FIG. 7, explanation thereof is omitted.

In Step S710, a process of activating the filter 350a and a process of registering the filter 350a in the filter managing part 330 are performed. Since the processes in Step S710 are the same as those in Steps S202 to S207 of FIG. 11, explanation thereof is omitted.

In Step S711, the local UI part 11 updates the display of the operations panel. Since the processes in Step S711 are the same as those in Steps S406 to S408 of FIG. 14, explanation thereof is omitted.

FIG. 19C shows an example of the control screen updated by the local UI part 11 in Step S711. In comparison with FIG. 19A, FIG. 19C shows a button “transmit fax” being added to the output selection panel.

With the processes in Steps S701 to S712, the filter 350a can be added to the MFP 1, to thereby realize the function corresponding to the filter 350a. As shown in FIG. 20, the processes performed in the activation of the MFP 1 are substantially the same as adding the filter 350a to the MFP 1. More specifically, after the plug-in is downloaded (processes after Step S705), the difference with respect to the activation operation of the MFP 1 is the additional process of adding a filter to the plug-in address storing part 211 (Step S706).

In other words, since the processes are substantially the same between the case of activating the MFP 1 and the case of adding a filter to the MFP 1, parts (components) for performing various processes can be shared. For example, in a case where the parts (components) for performing are programs, the storage capacity of the storage device of the MFP 1 for storing the programs can be reduced. Furthermore, by adding a filter to the plug-in address storing part 211, the newly added filter can be used the next time the MFP 1 is activated.

FIGS. 21A-21C are schematic diagrams for describing the contents in the plug-in address storing part 211 before and after the plug-in including the filter 350a is added to the MFP 1. More specifically, FIG. 21A shows the contents of the plug-in address storing part 211 before the filter 350a is added. FIG. 21A shows plug-ins which are already installed in the MFP 1 (pre-installed plug-ins) such as the “request managing part”, the “filter managing part”, the “local UI part”, and the “filter 350b” and addresses which these plug-ins are stored.

FIG. 21B shows addresses of plug-ins corresponding to the screen of FIG. 19B. That is, FIG. 21B shows a list that can be obtained by communicating with an outside server for indicating addable plug-ins.

FIG. 21C shows the contents of the plug-in address storing part 211 after the plug-in including the filter 350a is added. The contents correspond to the data updated in Step S706 of FIG. 20.

### (Process of Deleting Filter 350a from MFP 1)

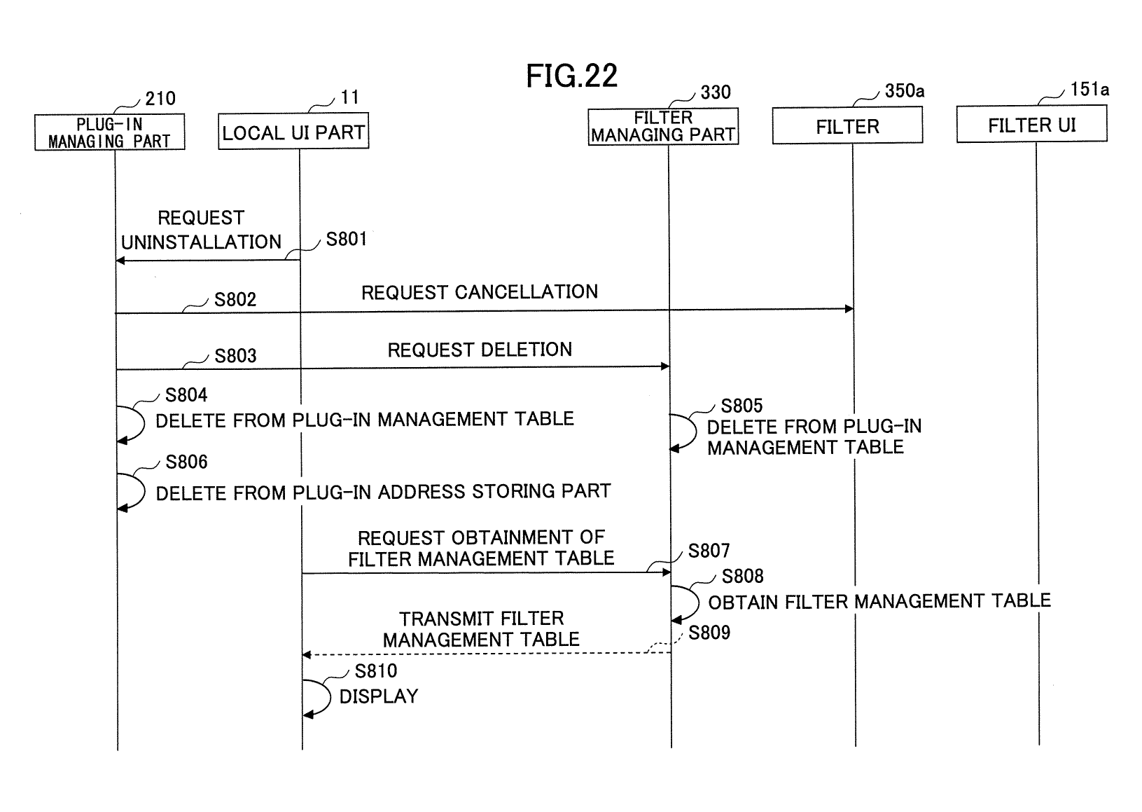

FIG. 22 is a sequence diagram showing an example of deleting the filter 350a from the MFP 1. In FIG. 22, the filter 350a of the MFP 1 is deleted based on an instruction to delete the filter from the operations panel, for example.

In Step S801 of FIG. 22, the local UI part 11 outputs a request for uninstalling the filter 350a to the plug-in managing part 210 based on an instruction to delete (uninstall) the filter from the operations panel.

In Step S802, the plug-in managing part 210 transmits a cancellation request to the filter 350a. In a case where the filter 350a is a program, the cancellation request may be to delete the program or delete the address corresponding to the program from the management table stored in a storage device. Furthermore, in a case where the filter 350a is an apparatus (device), the cancellation request may be to stop the supply of power to the apparatus (device).

In Step S803, the plug-in managing part 210 outputs a request for deleting the filter from the filter managing table to the filter managing part 330. In Step S804, the plug-in managing part 210 deletes the action of the filter 350a and the action object corresponding to the action from the plug-in management table stored in the plug-in management table storing part 212. In Step S805, the plug-in managing part 330 deletes the function of the filter 350a and the registration of the action object corresponding to the function from the filter management table stored in the filter management table storing part 331.

In Step S806, the plug-in managing part 210 deletes data such as the address of the plug-in address storing part 211 where the plug-in including the filter 350a is stored.

The processes in Steps S807 to S810 are for updating the display of an operations panel with the local UI part 11. Since the processes in Steps S807 to S810 are the same as those in Steps S406 to S409 of FIG. 14, explanation thereof is omitted.

With the processes in Steps S801 to S810, the filter 350a can be deleted from the MFP 1.

### (A Case of Activating an MFP 1 Having a Filter Operable to Realize a Printing Function)

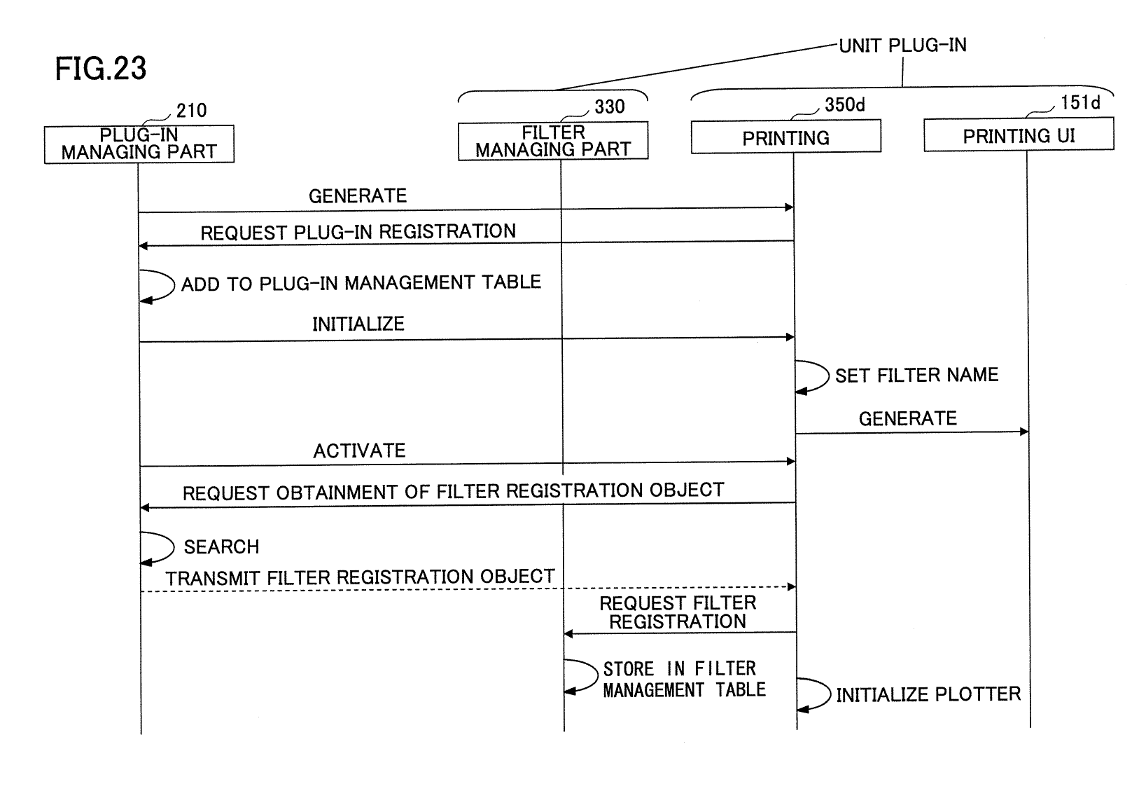

FIG. 23 is a sequence diagram showing a case of activating an MFP 1 having a filter (printing filter) 350d operable to realize a printing function. Since it can be understood that the MFP 1 can be activated for realizing the printing function by referring to FIGS. 7 and 11, explanation thereof is omitted.

### (Operation where MFP 1 is Activated (Part 2))

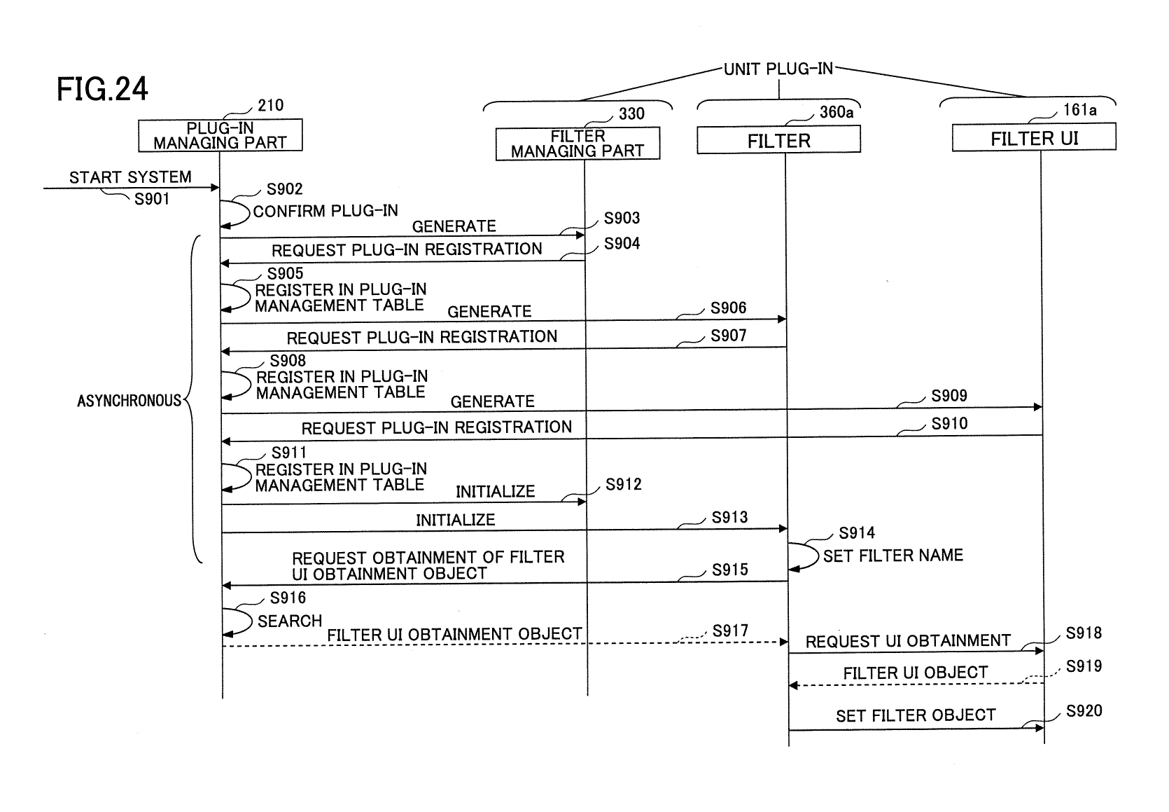

FIGS. 24-27 are diagrams for describing an operation in a case where the MFP 1 is activated (booted). In this case, filters and filter UIs are included in different plug-ins.

FIG. 24 is a sequence diagram showing processes of registering filters and filter UI of plug-ins in the plug-in managing part 210. In Step S901 of FIG. 24, an activation instruction is input to the plug-in managing part 210 upon supplying power to the MFP 1. Since the processes in Steps S902 to S908 of FIG. 24 are substantially the same as those of Steps S103 to S108 of FIG. 7 where processes performed on filter 350a in FIG. 7 correspond to those performed on filter 360a in FIG. 24, explanation thereof is omitted.

In Step S909, the plug-in managing part 210 outputs an instruction to generate a user-interface of a filter UI 161a to the filter UI 161a. Accordingly, the filter UI 161 generates the filter UI 161a. In Step S910, the filter UI 161a outputs a plug-in registration request to the plug-in managing part 210 for requesting registration of the action included in the filter UI 161a and the action object corresponding to the action. In Step S911, the plug-in managing part 210 registers the action included in the filter UI 161a and the action object corresponding to the action in the plug-in management table.

In Step S912, the plug-in managing part 210 outputs an instruction to initialize a part (component) to the filter managing part 330. Accordingly, the filter managing part 330 performs the initialization. In Step S913, the plug-in managing part 210 outputs an instruction to initialize the filter 360a to the filter 360a. Accordingly, the filter 360a performs the initialization. In Step S914, the filter 360a sets its name (filter name).

In the above-described Steps S903 to S914, the processes of the filter managing part 330, the processes of the filter 360a, and the processes of the filter UI 161a are performed in this order. Alternatively, instead of performing the processes in this order, the processes of the filter managing part 330, the filter 360a, and the filter UI 161a may be performed asynchronously.

In Step S915, the filter 360a transmits a request for obtaining a filter UI obtainment object to the plug-in managing part 210. In Step S916, the plug-in managing part 210 searches the filter UI 161a obtainment object from the plug-in management table of the plug-in management table storing part 212. In Step S917, the plug-in managing part 210 transmits the filter UI 161a obtainment object to the filter 360a.

In Step S918, the filter 360a outputs a filter UI obtainment request to the filter UI 161a based on the filter UI 161a obtainment object obtained in Step S917. In Step S919, the filter UI 161a outputs a filter UI object to the filter 360a. In Step S920, the filter 360a outputs a request to set a filter object to the filter UI 161a based on the filter UI object obtained in Step S919. Accordingly, the filter UI 161a sets the filter object.

With the processes in Steps S901 to S920, a plug-in management table of the plug-ins including the filters of the MFP 1 can be generated. Furthermore, with the processes in Steps S915 to S920, the filter UI 161a included in a plug-in different from the filter 360a can be set in accordance with the filter 360a.

### (Example of a Case where a Filter and a Filter UI are Included in Different Plug-Ins)

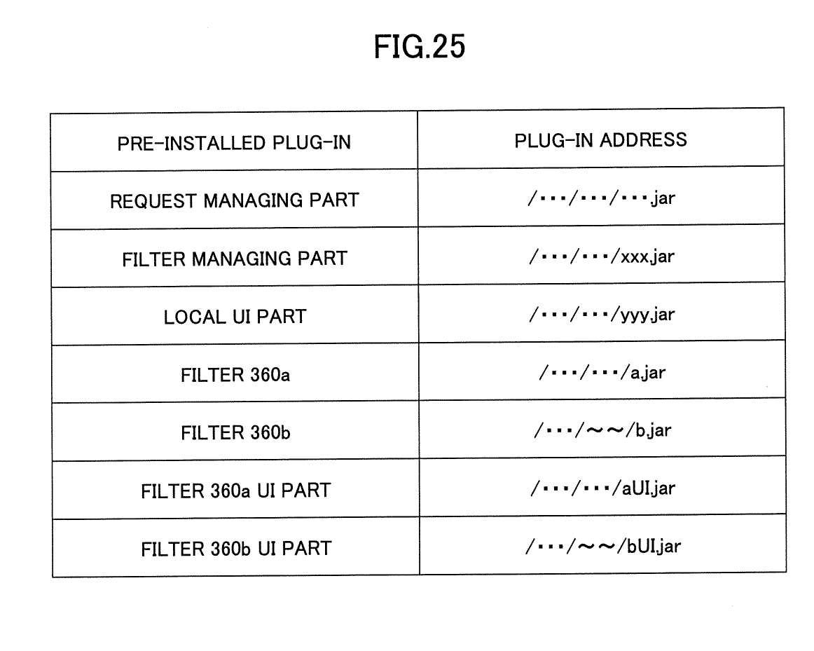

FIG. 25 shows plug-in addresses stored in the plug-in address storing part 211 in a case where a filter(s) and filter UI(s) are included in different plug-ins. In comparison with the table shown in FIG. 8, FIG. 25 also includes the addresses of the plug-ins of filter UIs. More specifically, in addition to the addresses corresponding to the “filter 360a” and the “filter 360b”, the “UI of filter 360a (filter 360a UI)” and the “UI of filter 360b (filter 360b UI)” are stored in corresponding plug-ins.

### (Action Object in a Case where a Filter and a Filter UI are Included in Different Plug-Ins)

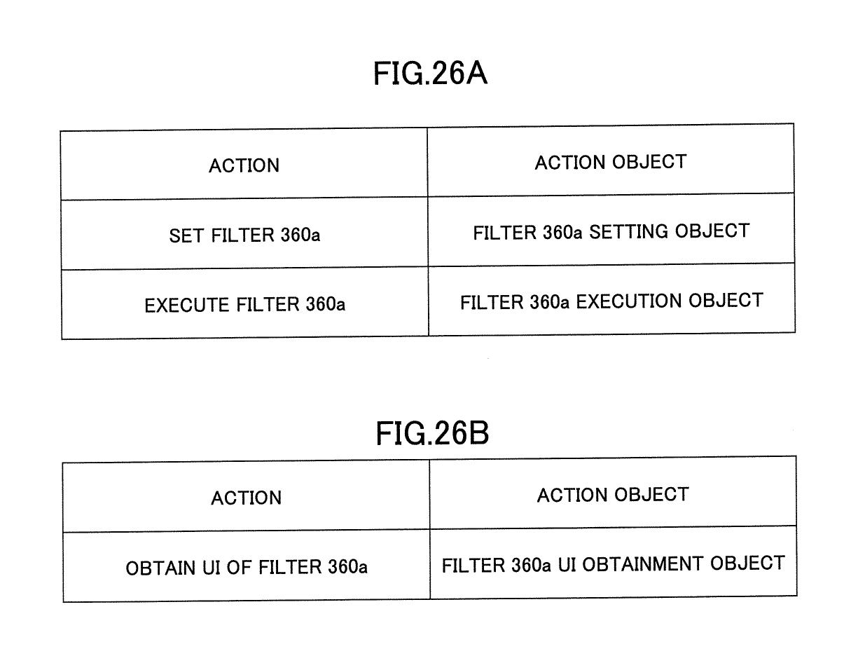

FIGS. 26A and 26B show examples of an action object in a case where a filter(s) and a filter UI(s) are included in different plug-ins. That is, FIGS. 26A and 26B show data that are output together with a plug-in registration request to the plug-in managing part in Steps S907 and S910 of FIG. 24.

FIG. 26A is a table showing actions of the filter 360a and action objects corresponding to the actions. Meanwhile, FIG. 26B is a table showing actions of the filter UI 161a (i.e. UI of filter 360a) and action objects corresponding the actions. In addition to requesting registration of the filter, registration of the filter UI is also requested to the plug-in managing part 210 in the case where the filter UI and the filter are included in different plug-ins. Thereby, the plug-in managing part 210 can manage the filter UI.

### (Registration to Filter Managing Part 330 in a Case where a Filter and a Filter UI are Included in Different Plug-Ins)

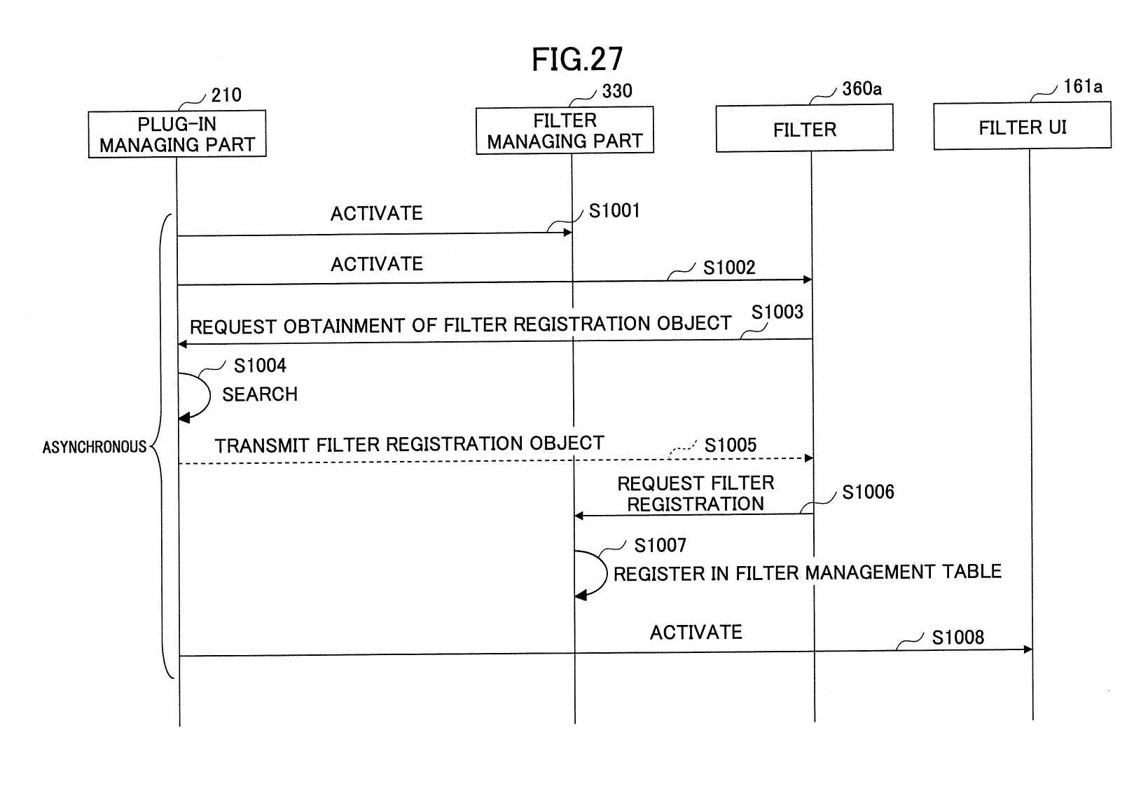

FIG. 27 is a sequence diagram showing processes of registering a filter to the filter managing part 330 in a case where a filter(s) and a filter UI(s) are included in different plug-ins. The processes in Step S1001 to S1008 are substantially the same as those of Steps S201 to S208 of FIG. 11. More specifically, the processes performed on the filter 360a of FIG. 27 are substantially the same as those performed on the filter 350a of FIG. 11 and the remaining processes in FIG. 27 and FIG. 11 are the same. Therefore, explanation thereof is omitted.

In FIG. 27, the filter 360a has, for example, its function(s) registered in the filter management table stored in the filter management table storing part 331. Meanwhile, the function of the filter UI 161a and the function object corresponding to the function are not registered in the filter management table. Furthermore, the filter 360a manages the filter UI 161a.

In addition to the processes shown in FIGS. 24 and 27, processes such as generation and activation of the local UI part 11 and the request managing part 220 are performed when the MFP 1 is activated. However, since such processes as generating the local UI part 11 and the request managing part 220 are the same as those of FIGS. 13 and 14, explanation thereof is omitted.

### (Example of Installing a Filter in a Case where a Filter and a Filter UI are Included in Different Plug-Ins)

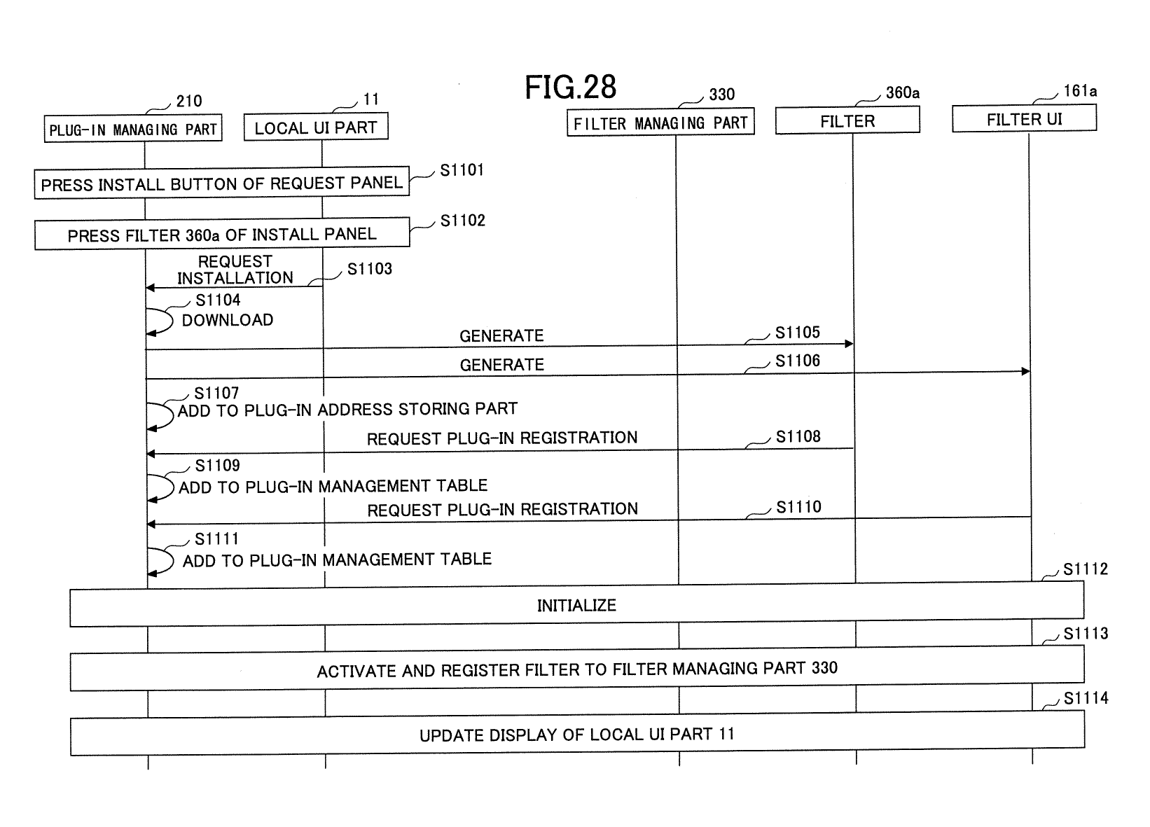

FIG. 28 is a sequence diagram showing processes for adding, for example, a filter to the MFP 1 in a case where a filter(s) and a filter UI(s) are included in different plug-ins. In FIG. 28, a filter, for example, is added to the MFP 1 based on an instruction “install” input from the operations panel by the user. The display of the operations panel is substantially the same in the case where the filter and the filter UI are included in a single plug-in as shown in FIG. 20.

In Step S1101 of FIG. 28, the button “install” on the operations panel is selected by the user (See FIG. 19A). Accordingly, the display of the operations panel is switched to the screen shown in FIG. 19B. In Step S1102, the user selects the filter displayed on the operations panel and presses a button commanding to start installation.

In Step S1103, the local UI part 11 outputs an installation request to the plug-in managing part 210. In Step S1104, the plug-in managing part 210 downloads a plug-in corresponding to the filter to be installed and a plug-in corresponding to the filter UI to be installed. The plug-in managing part 210 may download the plug-ins from an outside server (not shown) via the communication server part 12 or obtain the plug-ins from a storage device (not shown) of the MFP 1. Although this example of FIG. 28 describes the plug-in as a program, the plug-in may alternatively be an apparatus (device). In a case where the plug-in is an apparatus (device), the plug-in may be added by connecting the apparatus (device) connecting to the MFP instead of downloading.

In Step S1105, the plug-in managing part 210 outputs an instruction for generating a filter 360a (generation of filter) to the filter 360a. Accordingly, the filter 360a generates the filter 360a. In Step S1106, the plug-in managing part 210 outputs an instruction for generating a filter UI 161a (generation of filter UI) to the filter UI 161a. Accordingly, the filter UI 161a generates the filter UI 161a.

In Step S1107, the plug-in managing part 210 stores the address of the plug-in including the filter 350a and the address of the plug-in including the filter UI 161a in the plug-in address storing part 211.

In Step S1108, the filter 360a outputs a request for registering the plug-in including the filter 360a to the plug-in managing part 210. In Step S1109, the plug-in managing part 210 registers the action of the filter 360a and the action object corresponding to the action in the plug-in management table. In Step S1110, the filter UI 161a outputs a request for registering the plug-in including the filter UI 161a to the plug-in managing part 210. In Step S1111, the plug-in managing part 210 registers the action of the filter UI 161a and the action object corresponding to the action in the plug-in management table.

In Step S1112, the filter 360a and the filter UI 161a are initialized. Since the processes in the initialization of Step S1112 are the same as those in Steps S912 to S920 of FIG. 24, explanation thereof is omitted.

In Step S1113, a process of activating the filter 350a and the filter UI 161a and a process of registering the filter 350a and the filter UI 161a in the filter managing part 330 are performed. Since the processes in Step S1113 are the same as those in Steps S1002 to S1008 of FIG. 27, explanation thereof is omitted.

In Step S1114, the local UI part 11 updates the display of the operations panel. Since the processes in Step S1114 are the same as those in Steps S406 to S408 of FIG. 14, explanation thereof is omitted.

With the processes of Steps S1101 to S1114, the filter 360a and the filter UI 161a can be added to the MFP 1, to thereby realize the functions corresponding to the filter 350a and the filter UI 161a. As shown in FIG. 28, the processes performed in the activation of the MFP 1 are substantially the same as adding the filter 360a and the filter UI 161a to the MFP 1. More specifically, after the plug-in is downloaded (processes after Step S1105), the difference with respect to the activation operation of the MFP 1 is the additional process of adding a filter to the plug-in address storing part 211 (Step S1107).

In other words, since the processes are substantially the same between the case of activating the MFP 1 and the case of adding a filter to the MFP 1, parts (components) for performing various processes can be shared. For example, in a case where the parts (components) for performing are programs, the storage capacity of the storage device of the MFP 1 for storing the programs can be reduced. Furthermore, by adding a filter to the plug-in address storing part 211, the newly added filter can be used the next time the MFP 1 is activated.

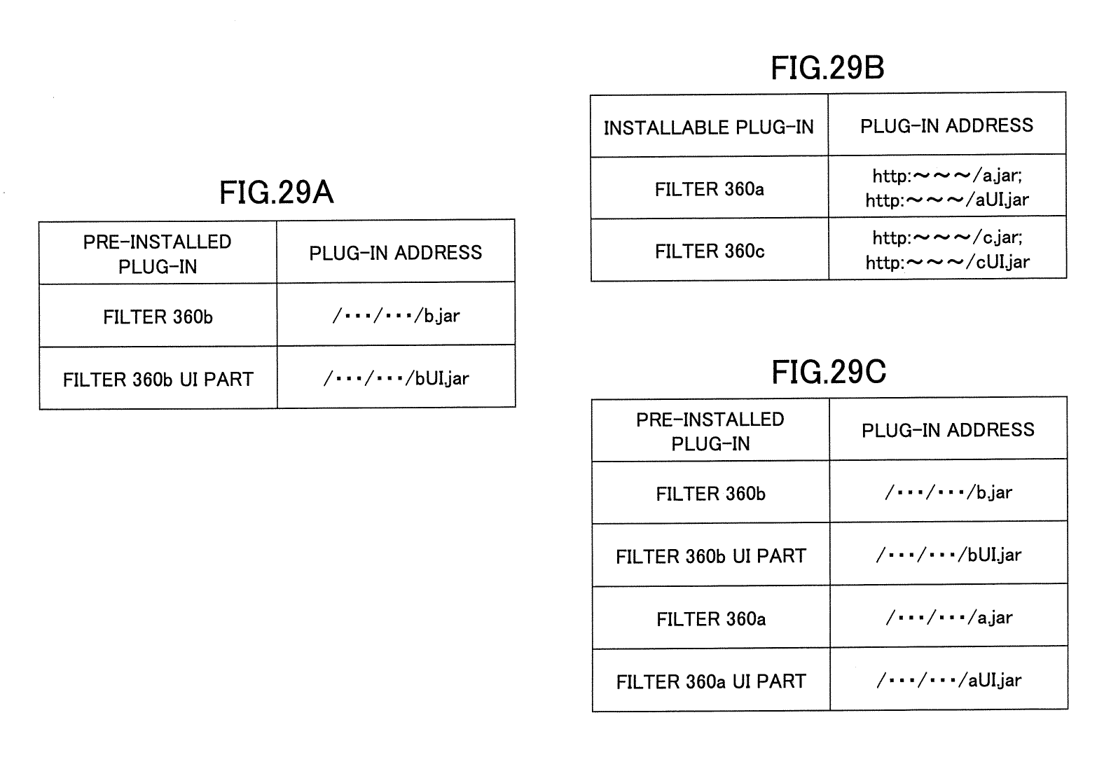

FIGS. 29A-29C are schematic diagrams for describing the contents in the plug-in address storing part 211 before and after the plug-in including the filter 360a is added to the MFP 1. It is to be noted that information (data) of the filter managing part 330 and the request managing part 210 are omitted in FIGS. 29A-29C. More specifically, FIG. 29A shows the contents of the plug-in address storing part 211 before the filter 360a is added. FIG. 29A shows plug-ins which are already installed in the MFP 1 (pre-installed plug-ins) such as the “filter 360a” and the “filter UI 161a” and addresses which these plug-ins are stored.

FIG. 29B shows addresses of plug-ins corresponding to the screen of FIG. 29B. That is, FIG. 29B shows a list that can be obtained by communicating with an outside server for indicating addable plug-ins. FIG. 29B shows plug-ins such as the “filter 360a” and the “filter 360c”, addresses which these plug-ins are stored, and addresses of plug-ins corresponding to the filter UI. Thereby, the filter and the filter UI are downloaded and added to the MFP according to the function (filter name) selected to be installed by the user.

FIG. 29C shows the contents of the plug-in address storing part 211 after the plug-in including the filter 360a and the plug-in including the filter UI 161a are added. The contents correspond to the data updated in Step S1114 of FIG. 28.

### (Process of Deleting Filter 360a from MFP 1)

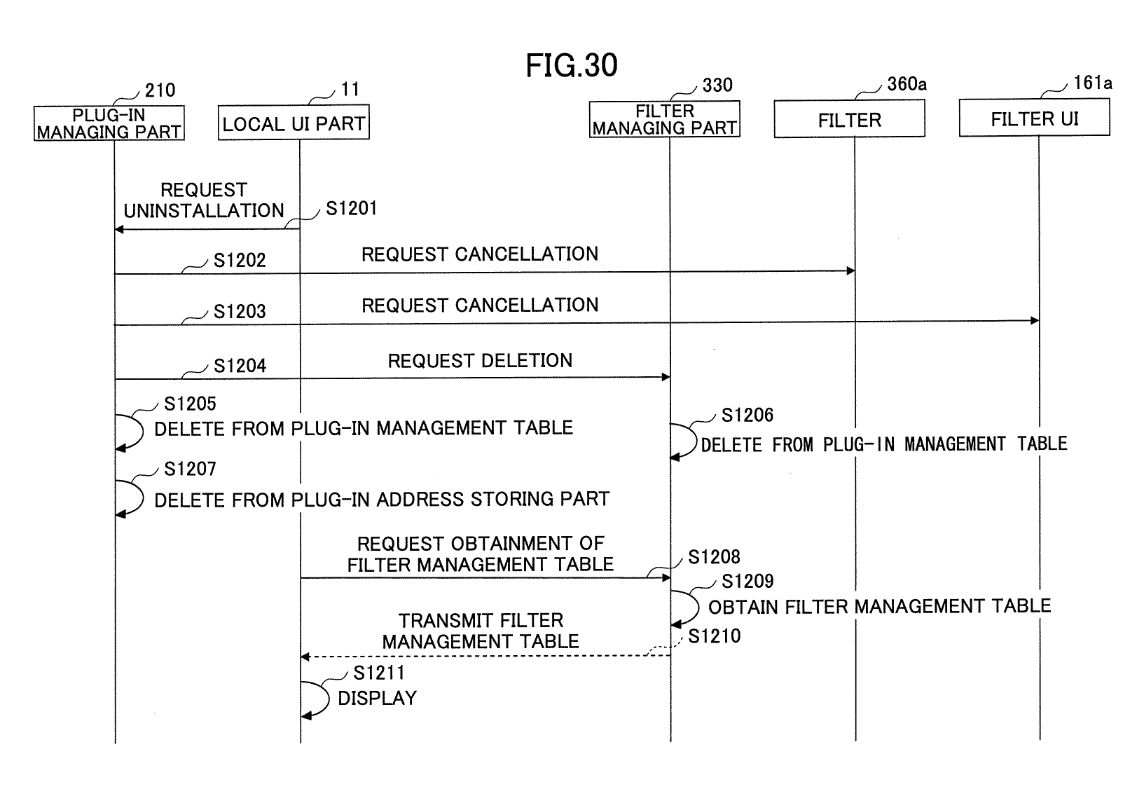

FIG. 30 is a sequence diagram showing an example of deleting the filter 360a from the MFP 1. In FIG. 30, the filter 360a of the MFP 1 is deleted based on an instruction to delete the filter from the operations panel, for example.

In Step S1201 of FIG. 30, the local UI part 11 outputs a request for uninstalling the filter 360a to the plug-in managing part 210 based on an instruction to delete (uninstall) the filter from the operations panel.

In Step S1202, the plug-in managing part 210 transmits a cancellation request to the filter 360a. In a case where the filter 360a is a program, the cancellation request may be to delete the program or delete the address corresponding to the program from the management table stored in a storage device. Furthermore, in a case where the filter 360a is an apparatus (device), the cancellation request may be to stop the supply of power to the apparatus (device).

In Step S1203 or prior to Step S1202, the plug-in managing part 210 transmits a cancellation request to the filter UI 161a. The content of the cancellation request is substantially the same as that transmitted to the filter 360a. In Step S1204, the plug-in managing part 210 outputs a request for deleting the filter from the filter managing table to the filter managing part 330. In Step S1205, the plug-in managing part 210 deletes the action of the filter 360a and the action object corresponding to the action from the plug-in management table. In Step S1206, the plug-in managing part 330 deletes the function of the filter 360a and the registration of the function object corresponding to the function from the filter management table stored in the filter management table storing part 331.

In Step S1207, the plug-in managing part 210 deletes data such as the address of the plug-in address storing part 211 where the plug-in including the filter 360a and the plug-in including the filter UI 161a are stored.

The processes in Steps S1208 to S1211 are for updating the display of an operations panel with the local UI part 11. Since the processes in Steps S1208 to S1211 are the same as those in Step S1114 of FIG. 28, explanation thereof is omitted.

With the processes in Steps S1201 to S1211, the filter 360a and the filter UI 161a can be deleted from the MFP 1. That is, by inputting an instruction to delete the filter 360a to the operations panel in Step S1201 or prior to Step S1201, the user can delete the filter 360a together with the filter UI 161a.

Hence, the above-described embodiments of the present invention can provide an image processing apparatus to which one or more functions can be easily added or changed. Thereby, one or more functions, which were unanticipated at the time of manufacture of the image processing apparatus, can be easily added to the image processing apparatus.

### Second Example

Next, other embodiments of the present invention are described. In the description below, like components and parts may be described and denoted by like numerals as of the above-described first embodiment of the present invention and are further explained.

An embodiment of the present invention provides an image processing apparatus to which a plug-in can be added, the plug-in having at least one filter corresponding to a process constituting a job for conducting an image processing operation, the image processing apparatus including a plug-in managing part for registering the plug-in and managing the registered plug-in, and a filter managing part for registering filter data of the filter and managing the registered filter data.

In the image processing apparatus according to an embodiment of the present invention, the plug-in managing part processing apparatus includes a plug-in address storing part for storing the address where the plug-in is stored, a plug-in management table storing part for storing a plug-in management table used for managing an action of the filter included in the plug-in and an action object corresponding to the action.

In the image processing apparatus according to an embodiment of the present invention, the filter managing part includes a filter management table storing part for storing a filter management table used for managing a function of the filter and a function object corresponding to the function.

In the image processing apparatus according to an embodiment of the present invention, in a case where a user-interface corresponding to the filter is included in a plug-in different from the plug-in having the filter, when activating the image processing apparatus or adding the plug-in including the filter to the image processing apparatus, the plug-in managing part registers the plug-in having the filter and the plug-in including the user-interface and manages the registered plug-ins, the filter managing part registers the filter and manages the filter, wherein the filter includes a user-interface managing part for obtaining the user-interface and managing the obtained user-interface.

In the image processing apparatus according to an embodiment of the present invention, in a case where a user-interface corresponding to the filter is included in a plug-in different from the plug-in having the filter, when deleting the plug-ins, the plug-in managing part deletes the registration of the plug-in having the filter and the registration of the plug-in including the user-interface, wherein the filter managing part deletes the registration of the filter.

Furthermore, another embodiment of the present invention provides an image processing method for an image processing apparatus to which a plug-in including at least one filter corresponding to a process constituting a job for conducting an image processing operation is added, the image processing method including: a plug-in managing step for registering the plug-in and managing the registered plug-in; a filter managing step for registering filter data of the filter and managing the registered filter data.

In the image processing method according to an embodiment of the present invention, the plug-in management step includes a plug-in address storing step for storing the address where the plug-in is stored, and a plug-in management table storing step for storing a plug-in management table used for managing an action of the filter included in the plug-in and an action object corresponding to the action.

In the image processing method according to an embodiment of the present invention, the filter managing step includes a filter management table storing step for storing a filter management table used for managing a function of the filter and a function object corresponding to the function.

In the image processing method according to an embodiment of the present invention, in a case where a user-interface corresponding to the filter is included in a plug-in different from the plug-in having the filter, when activating the image processing apparatus adding the plug-in including the filter to the image processing apparatus, the plug-in managing step registers the plug-in having the filter and the plug-in including the user-interface and manages the registered plug-ins.

In the image processing method according to an embodiment of the present invention, in a case where a user-interface corresponding to the filter is included in a plug-in different from the plug-in having the filter, when activating the image processing apparatus adding the plug-in including the filter to the image processing apparatus, the filter managing step registers the filter and manages the registered filter, wherein the filter includes a user-interface managing step for obtaining the user-interface and managing the obtained user-interface.

In the image processing method according to an embodiment of the present invention, in a case where a user-interface corresponding to the filter is included in a plug-in different from the plug-in having the filter, when deleting the plug-ins, the plug-in managing step deletes the registration of the plug-in having the filter and the registration of the plug-in including the user-interface, wherein the filter managing step deletes the registration of the filter.

Furthermore, another embodiment of the present invention provides a computer-readable recording medium on which a program is recorded for causing a computer to execute an image processing method used for an image processing apparatus to which a plug-in including at least one filter corresponding to a process constituting a job for conducting an image processing operation is added, the image processing method including a plug-in managing step for registering the plug-in and managing the registered plug-in and a filter managing step for registering filter data of the filter and managing the registered filter data.

Hence, the above-described embodiments of the present invention can provide an image processing apparatus to which one or more functions can be easily added or changed by separately managing the functions physically and logically. This allows easy addition or change of one or more functions for the image processing apparatus.

Further, the present invention is not limited to these embodiments, but variations and modifications may be made without departing from the scope of the present invention.

The present application is based on Japanese Priority Application Nos. 2006-240748 and 2006-240749 both filed on Sep. 5, 2006, with the Japanese Patent Office, the entire contents of which are hereby incorporated by reference.

What is claimed is:

1. An image processing apparatus to which a plug-in can be added, the plug-in having at least one filter corresponding to a process constituting a job for conducting an image processing operation, the image processing apparatus comprising:
a plug-in managing part for managing the plug-in; and
a plug-in registration requesting part for requesting the plug-in management part to register the plug-in in a case where the image processing apparatus is activated or where the plug-in is added to the image processing apparatus.

2. The image processing apparatus as claimed in claim 1, wherein the plug-in registration requesting part includes a part for requesting registration of an action of the filter included in the plug-in and an action object corresponding to the action.

3. The image processing apparatus as claimed in claim 1, further comprising:
a filter managing part for managing the filter; and
a filter registration requesting part for requesting the filter managing part to register the filter in a case where the image processing apparatus is activated or the plug-in is added to the image processing apparatus.

4. The image processing apparatus as claimed in claim 3, wherein the filter registration requesting part includes a part for requesting registration of a function of the filter and a function object corresponding to the function.

5. The image processing apparatus as claimed in claim 3, further comprising:
a UI plug-in including a user-interface part;
wherein the user-interface part includes a filter management table obtaining part for obtaining a filter management table indicative of the filter managed by the filter managing part;
wherein the filter management table obtaining part obtains the filter management table after every filter included in the plug-in managed by the plug-in managing part is registered in the filter managing part in a case where the image processing apparatus is activated.

6. The image processing apparatus as claimed in claim 5, wherein the filter management table obtaining part obtains the filter management table in a case where the plug-in is added or in a case where the plug-in is deleted.

7. The image processing apparatus as claimed in claim 2, further comprising:
a request managing part for selecting the filter according to the job;
wherein the request managing part obtains an operation object corresponding to an operation of a filter used for executing the job from the plug-in managing part.

8. The image processing apparatus as claimed in claim 1, wherein the plug-in managing part updates a plug-in management table and address data of the plug-in stored therein.

9. The image processing apparatus as claimed in claim 1, further comprising:
a user-interface section for receiving input from a user and indicating data to the user;
a control section including the plug-in managing part for controlling the job;
a function realizing section including the filter;
a device service section including a pipe intervening between the input and output of the filters; and
a device section including a device control part corresponding to each device.

10. The image processing apparatus as claimed in claim 3, wherein further comprising:
a user-interface section for receiving input from a user and indicating data to the user;
a control section for controlling various jobs;
a function realizing section including the filter managing part and the filter;
a device service section including a pipe for connecting the filters; and
a device section including a device controlling part provided in correspondence with each device included in the image processing apparatus.

11. An image processing method used for an image processing apparatus to which a plug-in including at least one filter corresponding to a process constituting a job for conducting an image processing operation is added, the image processing apparatus including a plug-in managing part for managing the plug-in and a filter managing part for managing the filter, the image processing method comprising:
a plug-in registration requesting step for requesting the plug-in management part to register the plug-in in a case where the image processing apparatus is activated or where the plug-in is added to the image processing apparatus.

12. The image processing method as claimed in claim 11, wherein the plug-in registration requesting step includes a step of requesting registration of an action of the filter included in the plug-in and an action object corresponding to the action.

13. The image processing method as claimed in claim 11, further comprising:
a filter registration requesting step for requesting the filter managing part to register the filter in a case where the image processing apparatus is activated or the plug-in is added to the image processing apparatus.

14. The image processing method as claimed in claim 13, wherein the filter registration requesting step includes a step for requesting registration of a function of the filter and a function object corresponding to the function.

15. The image processing method as claimed in claim 13, further comprising:
a filter management table obtaining step for obtaining a filter management table indicative of the filter managed by the filter managing part;
wherein the filter management table is obtained after every filter included in the plug-in managed by the plug-in managing part is registered in the filter managing part in a case where the image processing apparatus is activated.

16. The image processing method as claimed in claim 15, wherein the filter management table obtaining step includes obtains the filter management table in a case where the plug-in is added or in a case where the plug-in is deleted.

17. The image processing method as claimed in claim 12, further comprising:
a filter selecting step for selecting the filter according to the job;
wherein an operation object corresponding to an operation of a filter used for executing the job is obtained from the plug-in managing part.

18. The image processing method as claimed in claim 11, further comprising:
an updating step for updating a plug-in management table and address data of the plug-in stored in the plug-in managing part.

19. A computer-readable recording medium on which a program is recorded for causing a computer to execute an image processing method used for an image processing apparatus to which a plug-in including at least one filter corresponding to a process constituting a job for conducting an image processing operation is added, the image processing apparatus including a plug-in managing part for managing the plug-in and a filter managing part for managing the filter, the image processing method comprising:
a step for requesting the plug-in management part to register the plug-in in a case where the image processing apparatus is activated or where the plug-in is added to the image processing apparatus.
